(19) United States
(12) Patent Application Publication
(10) Pub. No.: US 2013/0069407 A1
(43) Pub. Date: Mar. 21, 2013

(54) CHAIR FOR EASY-SITTING AND EASY-RISING MOTIONS

(71) Applicants: Won Seuk Park, Seoul (KR); Hyung Seok Park, Seoul (KR)

(72) Inventors: Won Seuk Park, Seoul (KR); Hyung Seok Park, Seoul (KR)

(73) Assignees: FINEM.CO., LTD., Seoul (KR); Won Seuk Park, Seoul (KR)

(21) Appl. No.: 13/701,459

(22) PCT Filed: May 31, 2011
(86) PCT No.: PCT/KR2011/003978

§ 371 Date: Nov. 30, 2012

(30) Foreign Application Priority Data
May 31, 2010 (KR) 10-2010-0051373

(51) Int. Cl. A61G 5/14

(52) U.S. Cl. CPC A61G 5/14
USPC 297/313

(57) ABSTRACT

A chair for easy-sitting and easy-rising motions includes: a seat plate; a base that contacts the ground under the seat plate and supports a structure of the chair; an extensible support unit whose upper end portion is pivotably fixed to a rear portion of the seat plate and lower end portion is pivotably fixed to a front portion of the base; a second support rod whose upper end portion is pivotably fixed to the front portion of the seat plate and lower end portion is pivotably fixed to the rear portion of the base; and a guide rod that guides pivotal movements of the extensible support unit and the second support rod. When a user's weight is applied to the seat plate, since the seat plate is slowly lowered by changing its angle, the user may easily and safely sit on the chair, and the user may also easily rise from the chair.

### TECHNICAL FIELD

The present invention relates to a chair for easy-sitting and easy-rising motions, and more particularly, to a chair which, when a user's weight is applied to a seat plate, helps the user to safely sit on the chair by allowing a shock absorber connected to the seat plate to absorb an impact and the seat plate to be slowly and smoothly lowered by changing its angle as the user moves, and when the user sitting on the chair tries to rise by shifting his/her weight forward or takes an action to rise from the chair, helps the user to safely rise from the chair by allowing the seat plate to be raised by changing its angle due to an elastic force of a spring mounted on the shock absorber.

### BACKGROUND ART

The number of the old in developed countries such as the United States, Japan, and Europe as well as Korea has increased sharply in recent years as medical technologies have been developed and interest in health has increased. Accordingly, it is further important to develop appropriate devices and household items which may help the old not only to prevent and treat their diseases but also to live a life more conveniently and safely. For example, since it is very difficult for elderly people who have bad waists, hip joints, or knees to sit on and rise from the floor of a room, they often need to use chairs. However, when conventional chairs are used, they may flop down into the conventional chairs because they may not appropriately use their joints, thereby putting stress on their joints. Also, when they rise from the conventional chairs, they often need to hold something because they are not strong enough to rise by themselves. Accordingly, they have much difficulty in daily life.

Also, in modern society, the number of patients whose spines, waists, or leg joints are injured in various industrial accidents or traffic accidents has increased. When the patients whose spines, waists, or leg joints are injured abruptly flop down into chairs or gather their strength in order to rise from chairs, it may negatively affect the patients' bodies.

Accordingly, there are demands for chairs which may help the old, the weak or patients whose waists, leg joints, etc. are injured to safely and easily sit on and rise from chairs without much difficulty.

### DETAILED DESCRIPTION OF THE INVENTION

### Technical Problem

The present invention provides a chair in which a seat plate on which a user's hips may be placed may vertically move by changing its angle, and particularly, when the user's weight is applied to the seat plate, a shock absorber that supports the seat plate absorbs an impact and the seat plate is slowly and smoothly lowered by changing its angle, to help the user to easily and safely sit on the chair, and when the user tries to rise and slightly shifts his/her weight forward, the seat plate is raised by changing its angle due to an elastic force of a spring mounted on the shock absorber, to help the user to easily and safely rise from the chair.

### Technical Solution

According to an aspect of the present invention, there is provided a chair for easy-sitting and easy-rising motions, the chair including: a seat plate 2 on which a user's hips may be placed; a base 3 that is disposed under the seat plate 2 to contact the ground and supports a structure of the chair; an extensible support unit 600 whose upper end portion is pivotably fixed to a rear portion of the seat plate 2 and whose lower end portion is pivotably fixed to a front portion of the base 3; a second support rod 12 whose upper end portion is pivotably fixed to a front portion of the seat plate 2 and lower end portion is pivotably fixed to a rear portion of the base; and a guide rod 13 whose lower end portion is fixed to the base 3, and that is disposed between the extensible support unit 600 and the second support rod 12 and guides pivotal movements of the extensible support unit 600 and the second support rod.

According to another aspect of the present invention, there is provided a chair for easy-sitting and easy-rising motions, the chair including: a main seat plate 2a on which a user's hips may be placed; an auxiliary seat plate 2b that is disposed in front of the main seat plate 2a and is connected via a connection member 2c to the main seat plate 2a; a base 3 that is disposed under the main seat plate 2a and the auxiliary seat plate 2b to contact the ground and supports a structure of the chair; an extensible support unit 601 whose upper end portion is fixed to a bottom surface of the main seat plate 2a and lower end portion is fixed to the base 3 and an auxiliary seat plate support connection bar 303 whose one end is pivotably fixed to the auxiliary seat plate 2b and whose other end is pivotably fixed to the extensible support unit 601.

According to another aspect of the present invention, there is provided a chair for easy-sitting and easy-rising motions, the chair including: a seat plate 2 on which a user's hips may be placed; an extensible support unit 602 whose upper end is pivotably fixed to a rear portion of the seat plate 2 and lower end portion contacts the ground under a front portion of the seat plate 2; and a second support rod 12 whose upper end portion is pivotably fixed to the front portion of the seat plate 2 and lower end portion contacts the ground under the rear portion of the seat plate 2, wherein the extensible support unit 602 includes a first support rod 11 whose lower end portion contacts the ground, and a shock absorber 15 whose lower end portion is connected to the first support rod 11 and upper end portion is connected to the rear portion of the seat plate 2, wherein the first support rod 11 and the second support rod 12 which cross each other in an X shape are pivotably coupled to each other by using a rod coupling pin 400.

In order to achieve the objectives, some embodiments in which a seat plate is vertically smoothly moved by changing its angle have been suggested herein. However, since there may be various other embodiments other than the embodiments, the scope of the present invention is not limited to the attached drawings and descriptions thereof.

Also, in the embodiments of the present invention, a shock absorber and/or a spring for lowering/raising a seat plate of a chair may be replaced by a motor cylinder, a hydraulic cylinder, or a pneumatic cylinder which is driven by external power. Accordingly, not only a chair in which a seat plate is lowered/raised by changing its angle when a user's weight is applied or removed but also a chair in which a seat plate is forced to be lowered/raised by changing its angle by a mechanical device driven by external power such as a motor cylinder are included in the scope of the present invention.

### Advantageous Effects

Since a chair for easy-sitting and easy-rising motions according to the present invention may help the old, the weak, or patients who have bad waists, leg joints, etc. to easily and safely sit on and rise from the chair, the chair helps them to live a more comfortable life. In particular, since the chair may be applied to a variety of products, for example, a toilet seat as well as a general chair, the chair may greatly improve the welfare of the old, the weak, patients, and the disabled in daily life.

### DESCRIPTION OF THE DRAWINGS

FIG. 1 is a perspective view of a chair 1 for easy-sitting and easy-rising motions, according to an embodiment of the present invention.

FIG. 2 is a side view of the chair of FIG. 1, illustrating that a seat plate 2 of the chair 1 is raised.

FIG. 3 is a side view of the chair of FIG. 1, illustrating that a user P sits on the seat plate 2 of the chair 1 and thus the seat plate 2 is lowered.

FIG. 4 is a side view of the chair of FIG. 3, illustrating that when the user P sitting on the chair 1 tries to rise from the chair 1 by slightly shifting his/her weight forward or takes an action to rise from the chair 1, a shock absorber 15 extends due to an elastic force of a spring in the shock absorber 15 and thus the seat plate 2 is forced to be slightly raised.

FIG. 5 is a cross-sectional view of the shock absorber 15 used in the chair 1 of FIG. 1, according to an embodiment of the present invention.

FIG. 6 is a cross-sectional view of the shock absorber 15 of FIG. 5, illustrating that the shock absorber 15 compresses to the maximum.

FIG. 7 is a cross-sectional view of the shock absorber 15 of FIG. 5, illustrating that the shock absorber 15 extends to the maximum.

FIG. 8 is a cross-sectional view of a shock absorber 15a used in the chair 1, according to another embodiment of the present invention, illustrating that an outer spring 158a is mounted on a piston rod 16 outside an outer housing 155.

FIGS. 9 and 10 are cross-sectional views of a shock absorber 15b used in the chair 1, according to another embodiment of the present invention, illustrating that an adjustment knob 170 for adjusting an operation range of the shock absorber 15b or stopping an operation of the shock absorber 15b is provided.

FIG. 11 is a schematic side view of the chair 1 on which the shock absorber 15b of FIGS. 9 and 10 is mounted.

FIG. 12 is a perspective view of a chair 1a for easy-sitting and easy-rising motions, according to another embodiment of the present invention.

FIGS. 13 through 15 are side views of the chair 1a of FIG. 12, wherein FIG. 13 illustrates that the user does not completely sit on the chair 1a, FIG. 14 illustrates that the user completely sits on the chair 1a and thus a main seat plate 2a and an auxiliary seat plate 2b are lowered, and FIG. 15 illustrates that when the user tries to rise from the chair 1a, a shock absorber 310 extends due to an elastic force of a spring 203.

FIGS. 16 and 17 are side views of a chair 1b for easy-sitting and easy-rising motions, according to another embodiment of the present invention, illustrating that a first support rod 11 and a second support rod 12 that support the chair 1b in an X shape are fixedly supported by a rod coupling pin 400 and a lower end portion of the first support rod 11 may be moved by using a wheel 31a.

FIGS. 18 and 19 are side views illustrating a chair 1c for easy-sitting and easy-rising motions, according to another embodiment of the present invention, illustrating that the first support rod 11 and the second support rod 12 that support the chair 1c in an X shape are fixedly supported by the rod coupling pin 400 and a lower end portion of the second support rod 12 may be moved by a wheel 32b.

FIGS. 20 and 21 are side views for explaining an operation of a chair 1d for easy-sitting and easy-rising motions, according to another embodiment of the present invention.

FIGS. 22 and 23 are side views for explaining an operation of a chair 1e for easy-sitting and easy-rising motions, according to another embodiment of the present invention.

FIGS. 24 and 25 are side views for explaining an operation of a chair 1f for easy-sitting and easy-rising motions, according to another embodiment of the present invention.

FIG. 26 is a perspective view of a chair 1g for easy-sitting and easy-rising motions, according to another embodiment of the present invention, which is a modification of the chair 1a of FIG. 12.

FIG. 27 is a side view of a chair 1g for easy-sitting and easy-rising motions, according to another embodiment of the present invention.

FIG. 28 is a side rear perspective view of the chair 1h of FIG. 27.

FIGS. 29 and 30 are side views for explaining an operation of a chair 1i for easy-sitting and easy-rising motions, according to another embodiment of the present invention.

FIGS. 31 through 33 are side views for explaining an operation of a chair 1j for easy-sitting and easy-rising motions, according to another embodiment of the present invention.

### BEST MODE

According the best mode of the present invention, a chair for easy-sitting and easy-rising motions includes: a seat plate 2 on which a user's hips may be placed; a base 3 that contacts the ground under the seat plate 2 and supports a structure of the chair; an extensible support unit 600 whose upper end portion is pivotably fixed to a rear portion of the seat plate 2 and lower end portion is pivotably fixed to a front portion of the base 3; a second support rod 12 whose upper end portion is pivotably fixed to a front portion of the seat plate 2 and lower end portion is pivotably fixed to a rear portion of the base 3; and a guide rod 13 whose lower end portion is fixed to the base 3, and that is disposed between the extensible support unit 600 and the second support rod 12 and guides pivotal movements of the extensible support unit 600 and the second support rod 12.

### MODE OF THE INVENTION

The present invention will now be described more fully with reference to the accompanying drawings, in which exemplary embodiments of the invention are shown.

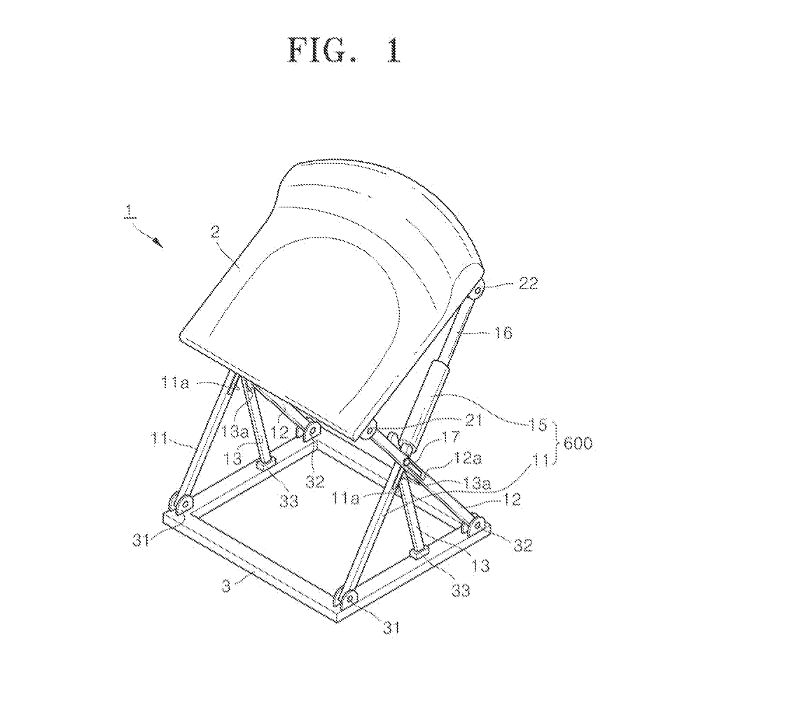

FIG. 1 is a perspective view of a chair 1 for easy-sitting and easy-rising motions, according to an embodiment of the present invention. Referring to FIG. 1, a seat plate 2 on which hips of a user P may be placed is supported by an extensible support unit 600 and a second support rod 12 which cross each other in an X shape under the seat plate 2, and the extensible support unit 600 includes a first support rod 11 and a shock absorber 15 which are coupled to each other.

The first support rod 11 and the second support rod 12 are pivotably coupled to a base 3 that contacts the ground under the seat plate 2. That is, an upper end portion of the first support rod 11 is coupled to the shock absorber 15, and a lower end portion of the first support rod 11 is pivotably coupled to a first lower connection hinge 31 that is disposed on a front portion of the base 3. An upper end portion of the second support rod 12 is pivotably coupled to a first upper connection hinge 21 that is provided on a bottom surface of a front portion of the seat plate 2, and a lower end portion of the second support rod 12 is pivotably coupled to a second lower connection hinge 32 that is disposed on a rear portion of the base 3. An extensible piston rod 16 of the shock absorber 15 is pivotably coupled to a second upper connection hinge 22 that is provided on a rear portion of the seat plate 2.

As shown in FIG. 1, since one first support rod 11, one shock absorber 15, one second support rod 12, and one guide rod 13 are provided on and support each of both sides of the chair 1, a structure and an operation of the chair 1 will be explained by focusing on only one side of the chair 1.

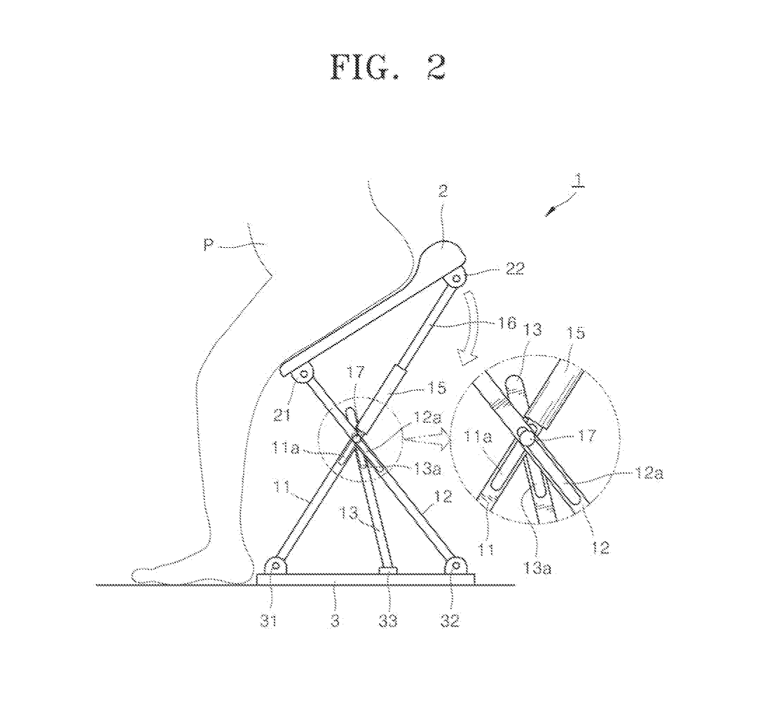

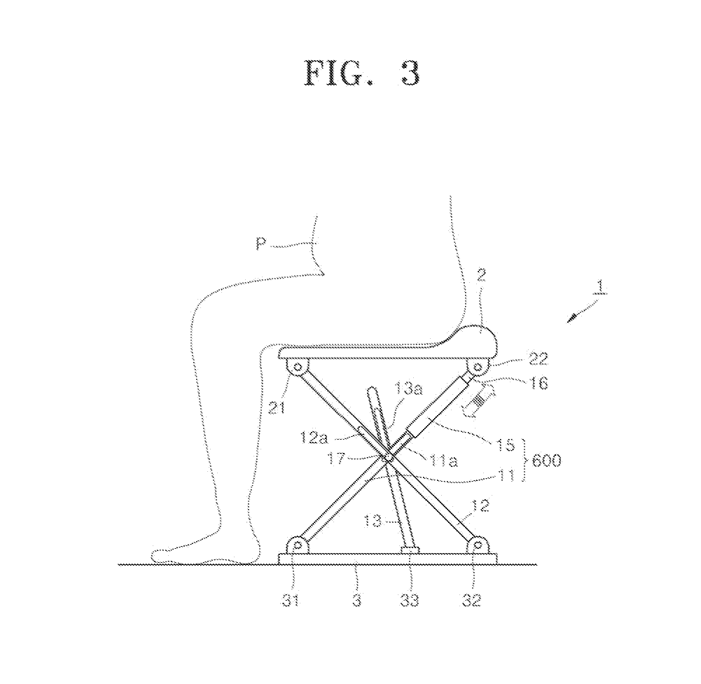

The first support rod 11 and the second support rod 12 are provided to cross each other in an X shape, and long grooves 11a and 12a are partially formed in the first support rod 11 and the second support rod 12 in longitudinal directions of the first support rod 11 and the second support rod 12, respectively. A guide long groove 13a is also partially formed in the guide rod 13 in a longitudinal direction of a guide rod 13 that is disposed between the first support rod 11 and the second support rod 12. A support rod connection pin 17 is inserted into long grooves, that is, the first movement groove 11a, the second movement groove 12a, and the guide long groove 13a, respectively formed in the first support rod 11, the second support rod 12, and the guide rod 13, such that positions of the first support rod 11, the second support rod 12, and the guide rod 13 may be changed. Accordingly, as shown in FIGS. 2 through 4, assuming that positions of the first support rod 11 and the second support rod 12 may be continuously changed along the guide long groove 13a formed in the guide rod 13, the chair 1 may be changed from a case where the seat plate 2 is raised to the maximum to be inclined (see FIGS. 1 and 2) to a case where the seat plate 2 is lowered to the maximum to be horizontal (see FIG. 3).

Since a lower end portion of the guide rod 13 is fixed to the base 3 and a fixing portion 33 fixes the guide rod 13 on the base, the guide rod 13 may be firmly held at its position irrespective of positions of the first support rod 11 (that is, the extensible support unit 600) and the second support rod 12.

FIG. 2 is a side view of the chair 1 of FIG. 1, illustrating that the seat plate 2 of the chair 1 is raised.

Referring to FIG. 2, when the user P does not sit on the chair 1, the seat plate 2 is inclined at about 20 to 45° forward, and the support rod connection pin 17 that couples the first support rod 11, the second support rod 12, and the guide rod 13 is located at a highest position of the guide long groove 13a. When a weight is not applied to the seat plate 2, the support rod connection pin 17 is also located at highest positions of the first connection groove 11a of the first support rod 11 and the second connection groove 12a of the second support rod 12.

However, when the user P tries to sit on the seat plate 2 by putting his/her hips on the seat plate 2 to apply his/her weight to the seat plate 2, the shock absorber 15 of the extensible support unit 600 begins to slowly compress. That is, the piston rod 16 is inserted into the shock absorber 15 to reduce an overall length of the extensible support unit 600, and the first support rod 11 rotates clockwise about the first lower connection hinge 31 in FIG. 2.

The second support rod 12 crossing the first support rod 11 rotates counterclockwise about the second lower connection hinge 32 in FIG. 2. As a result, the support rod connection pin 17 gradually moves to a lower position of the guide long groove 13a of the guide rod 13. Likewise, the support rod connection pin 17 moves to lower positions of the first movement groove 11a of the first support rod 11 and the second movement groove 12a of the second support rod 12.

According to the chair 1 of the present embodiment, even when the user P flops down into the chair 1, since the shock absorber 15 that supports the seat plate 2 slowly compresses to absorb an impact, the seat plate 2 which is inclined gets slowly lowered to be horizontal. That is, the chair 1 has an advantage in that since the seat plate 2 is slightly lowered by slowly changing its angle, the user P may comfortably sit on the chair 1. Accordingly, even the old, the weak, and the disabled who have bad waists and leg joints may safely sit on the chair 1 by applying their weights to the chair 1 without using others' help or without holding the chair 1 with hands.

FIG. 3 is a side view of the chair 1 of FIG. 1, illustrating that the user P completely sits on the seat plate 2 of the chair 1 and thus the seat plate 2 is lowered. Referring to FIG. 3, the seat plate 2 is maintained in a horizontal state, and the support rod connection pin 17 is located at lowest positions of the long grooves 11a, 12a, and 13a of the first support rod 11, the second support rod 12, and the guide rod 13.

As described above, the long grooves 11a, 12a, and 13a respectively formed in the first support rod 11, the second support rod 12, and the guide rod 13 guide positions of the first support rod 11, the second support rod 12, and the guide rod 13, and secure a highest position (see FIG. 2) and a lowest position (see FIG. 3) of the seat plate 2. That is, the highest position (see FIG. 2) of the seat plate 2 of the chair 1 is secured when the support rod connection pin 17 may not move upward by being blocked at upper end portions of the long grooves 11a, 12a, and 13a, and the lowest position (see FIG. 3) of the seat plate 2 of the chair 1 is secured when the support rod connection pin 17 may not move downward by being blocked at lower end portions of the long grooves 11a, 12a, and 13a.

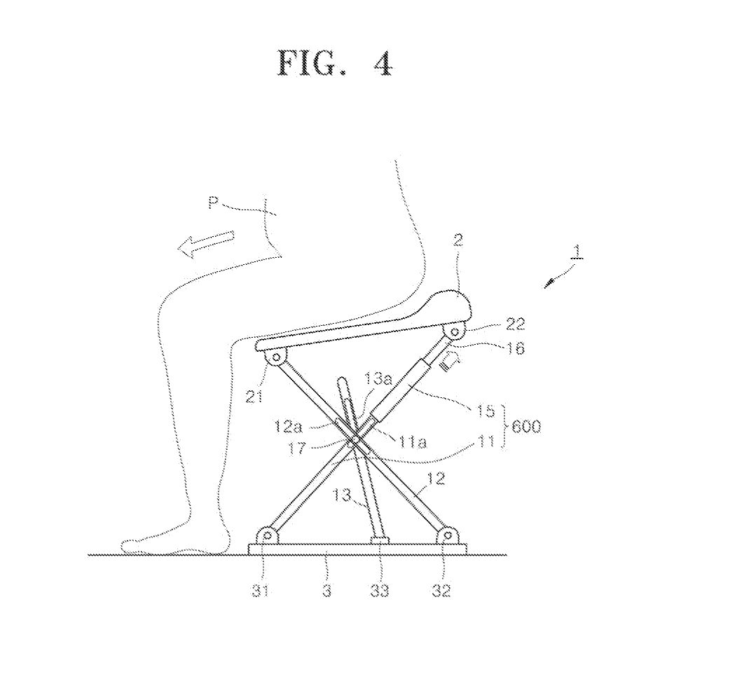

FIG. 4 is a side view of the chair 1 of FIG. 1, illustrating that when the user P tries to rise from the chair 1 by slightly shifting his/her weight forward or takes an action to rise from the chair 4, the shock absorber 15 extends due to an elastic force of a spring in the shock absorber 15 and thus the seat plate 2 is forced to be slightly raised.

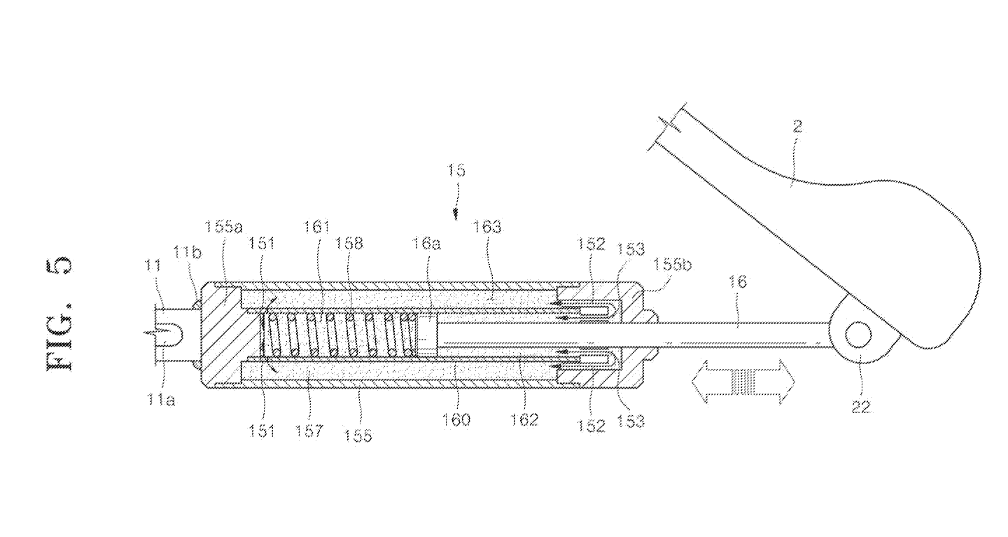

The chair 1 helps people who have bad waits or leg joints not only to easily sit on the chair 1, but also to easily rise from the chair 1 when they try to rise by slightly shifting their weights forward or by slightly raising their hips by extending the shock absorber 15 due to an elastic force of the spring 158 (see FIG. 5) in the shock absorber 15 and raising the seat plate 2 by changing an angle of the seat plate 2.

As shown in FIG. 4, when the user P sitting on the chair 1 shifts his/her weight forward or slightly raises his/her hips to rise from the chair 1, the shock absorber 15 coupled to the rear portion of the seat plate 2 extends, and thus the seat plate 2 is slightly raised to be slightly inclined forward, thereby making it possible for the user P to easily rise from the chair 1.

Assuming that people who have bad waists or leg joints try to rise, when a seat plate of a chair slightly pushes their hips upward, they may rise from the chair much easier. Considering this, since the chair 1 elastically supports the seat plate 2 by using the shock absorber 15 and the spring which are coupled to each other, when a weight is partially removed, the shock absorber 15 is designed to raise the seat plate 2 due to an elastic force of the spring. As a result, the user P may much more easily and safely rise from the chair 1 than from a conventional chair.

FIGS. 5 through 7 are cross-sectional views illustrating the shock absorber 15 used in the chair 1, according to an embodiment of the present invention.

A structure and a specification of the shock absorber 15 coupled to the first support rod 11 may vary according to specific cases. Also, since a variety of shock absorbers are currently commercially available, the shock absorbers may be appropriately used. Since the shock absorber 15 is one example of various shock absorbers applicable to the chair 1, it will be understood that the scope of the present invention is not limited to the following explanations and drawings of the shock absorber 15.

Referring to FIG. 5, an inner cylinder 160 is provided in a cylindrical outer housing 155, and the piston rod 16 is movably provided in first and second inner spaces 161 and 162 of the inner cylinder 160. A lower cover 155a is coupled to a lower end portion of the outer housing 155 to which the first support rod 11 is coupled, and an upper cover 155b is coupled to an upper end portion of the outer housing 155.

A working fluid, that is, oil 157, fills in all inner spaces of the outer housing 155. Although some shock absorbers are filled with gas (e.g., nitrogen), a case where oil is used as a working fluid will be exemplarily explained in the present embodiment. A plurality of first orifices 151 are formed in a lower end portion of the inner cylinder 160, and thus the working fluid (oil) 157 may flow into or out of the inner cylinder 160. A plurality of third orifices 153 are formed in an upper end portion of the inner cylinder 160 and second orifices 152 are formed between the inner cylinder 160 and the outer housing 155 to be adjacent to the third orifices 153, and thus the oil 157 may flow through the second orifices 152 and the third orifices 153.

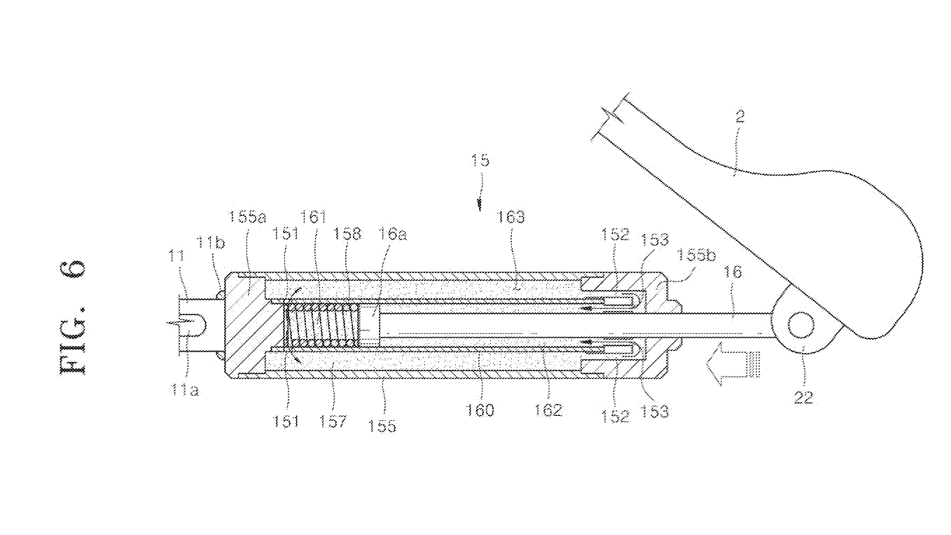

A piston head 16a of the piston rod 16 located in the inner cylinder 160 is always provided with an elastic force outside the shock absorber 15 due to the spring 158. In order for the shock absorber 15 to compress, the oil 157 in the first inner space 161 of the inner cylinder 160 has to flow to an outer space 163 through the first orifices 151 and the oil 157 in the outer space 163 has to flow into the second inner space 162 of the inner cylinder 160 through the second orifices 152 and the third orifices 153. However, since the first through third orifices 151, 152, and 153 are formed to have small sizes, even when the oil 157 is pressurized due to a movement of the piston rod 16, the oil 157 may not flow at one time through the first through third orifices 151, 152, and 153, thereby making the shock absorber 15 slowly compress according to a speed at which the oil 157 flows (see FIG. 6).

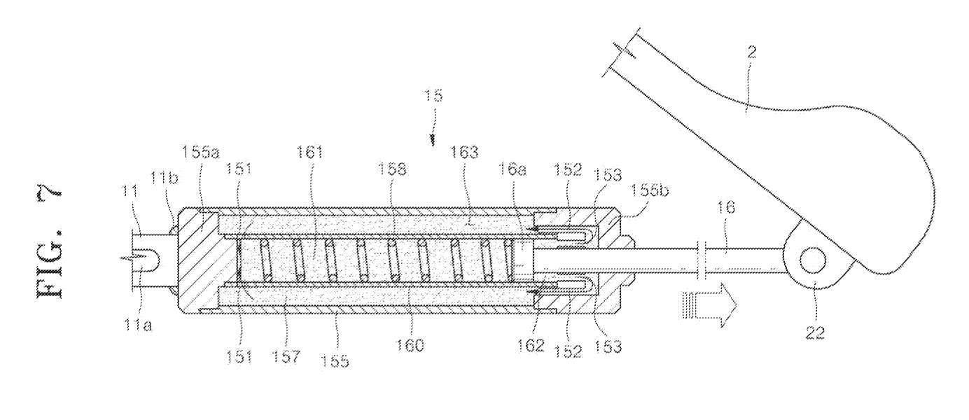

On the contrary, when an external load applied to the shock absorber 15 is removed and the shock absorber 15 extends due to an elastic force of the spring 158, the oil 157 in the second inner space 162 of the inner cylinder 160 flows to the outer space 163 through the third orifices 153 and the second orifices 152, and the oil 157 in the outer space 163 flows into the first inner space 161 of the inner cylinder 160 through the first orifices 151. Even in this case, since the piston rod 16 moves outward according to a speed at which the oil 157 passes through the narrow orifices 151, 152, and 153, the shock absorber 15 also extends slowly (see FIG. 7).

As such, since the shock absorber 15 slowly operates in a direction in which a force is applied, the seat plate 2 of the chair 1 is slowly lowered or raised.

The lower cover 155a of the shock absorber 15 may be coupled to the first support rod 11 by using welding or the like. Reference numeral 11b in FIGS. 5 through 10 denotes a welded portion between the first support rod 11 and the lower cover 155a.

FIG. 6 is a cross-sectional view of the shock absorber 15 of FIG. 5, illustrating that the shock absorber 15 compresses to the maximum. Referring to FIG. 6, the piston rod 16 is located at an innermost position of the inner cylinder 160 due to a load (a weight of the user P) applied to the seat plate 2, and the spring 158 compresses to the maximum due to the piston head 16a.

FIG. 7 is a cross-sectional view of the shock absorber 15 of FIG. 5, illustrating that the shock absorber 15 extends to the maximum. As shown in FIG. 7, when a weight of the user P is completely removed from the seat plate 2 and only an elastic force of the spring 158 is applied to the piston head 16a, the piston rod 16 moves to the maximum out of the inner cylinder 160.

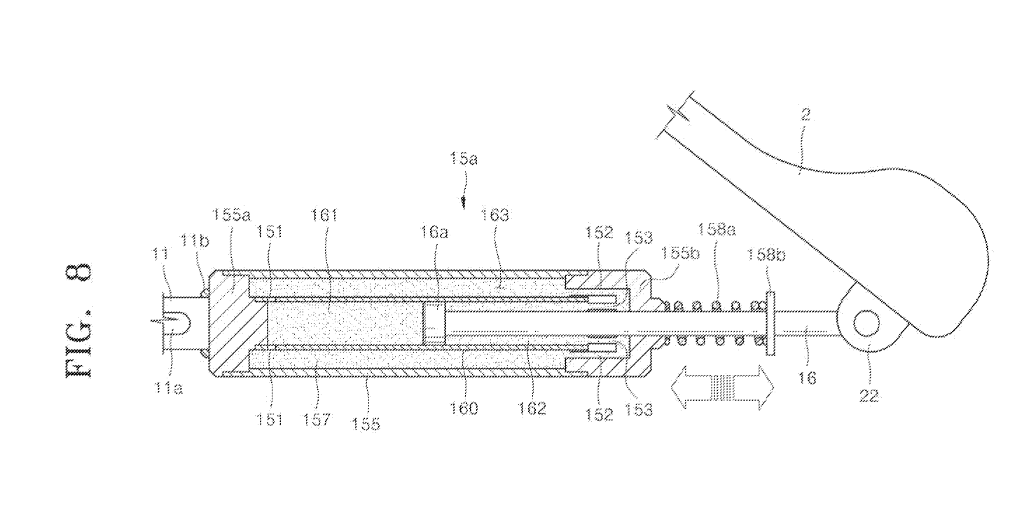

FIG. 8 is a cross-sectional view of a shock absorber 15a used in the chair 1, according to another embodiment of the present invention, illustrating that an outer spring 158a is mounted on the piston rod 16 outside the outer housing 155.

Although the spring 158 is provided in the shock absorber 15 in FIGS. 5 through 7, the present invention is not limited thereto and the spring 158 may be provided outside the shock absorber 15 as shown in FIG. 8. No spring is provided in an inner space of the inner cylinder 160, and the outer spring 158a is wound around the piston rod 16 to be adjacent to the upper cover 155b. In this case, by forming a spring fixing extrusion 158b at a predetermined position of the piston rod 16, an elastic force of the outer spring 158a may be applied to the piston rod 16.

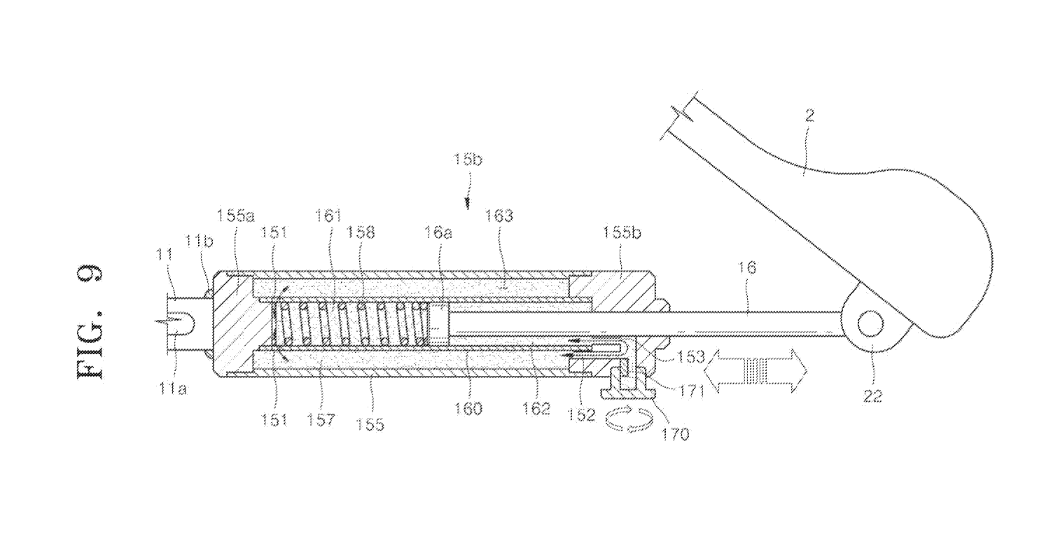

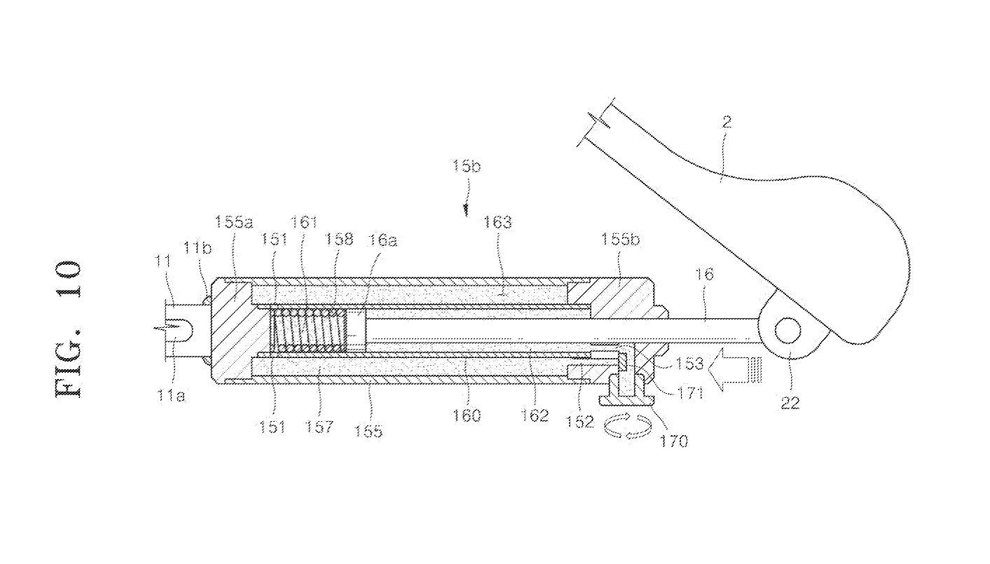

FIGS. 9 and 10 are cross-sectional views of a shock absorber 15b used in the chair 1, according to another embodiment of the present invention, illustrating that an adjustment knob 170 for adjusting an operation range of the shock absorber 15b or stopping an operation of the shock absorber 15b is provided.

Although the seat plate 2 of the chair 1 according to the present invention may vertically move, the seat plate 2 may need to be fixed (for example, to a state of FIG. 3) or an operation range may need to be adjusted according to a response speed of the shock absorber 15b in some cases. To this end, in FIGS. 9 and 10, an adjustment block 171 for blocking a path through which the oil 157 passes or adjusting a cross-sectional area of the path, and an adjustment knob 170 for changing a position of the adjustment block 171 from the outside are provided on the shock absorber 15b.

In FIG. 9, since the adjustment block 171 does not close the second orifices 152, the oil 157 normally flows in the shock absorber 15, like in FIGS. 5 through 8. However, when the adjustment block 171 closes the second orifices 152 (and the third orifices 153 as well) as shown in FIG. 10, since the oil 157 may not flow into or out of the inner cylinder 160, the shock absorber 15b is locked out.

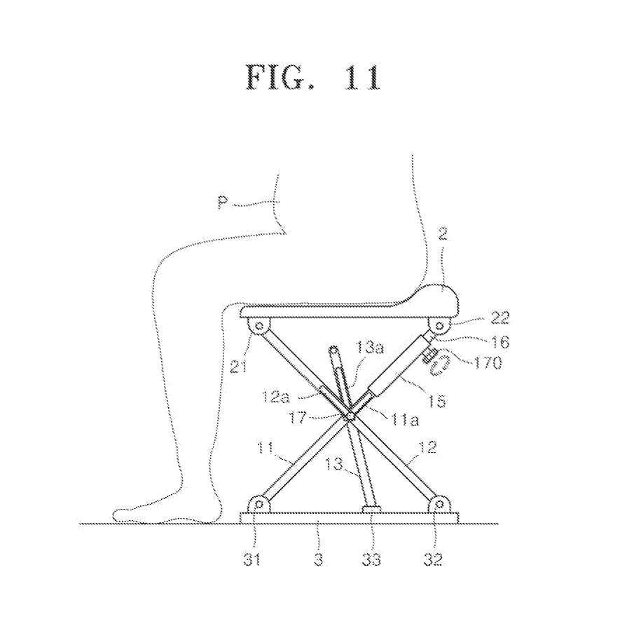

FIG. 11 is a schematic side view of the chair 1 on which the shock absorber 15b of FIGS. 9 and 10 is mounted.

Accordingly, the chair 1 may adjust a response speed of the chair 1 or lock out the shock absorber 15b by manipulating the adjustment knob 170 provided on the shock absorber 15b with a hand.

Although the adjustment block 171 is provided adjacent to the second orifices 152 and the third orifices 153 of the shock absorber 15b in FIGS. 9 and 10, the adjustment block 171 and the adjustment knob 170 may be provided adjacent to the first orifices 151. That is, the adjustment knob 170 for locking out the shock absorber 15b may be provided at any positions around the first through third orifices 151, 152, and 153, and there is no need to limit a position of the adjustment knob 170.

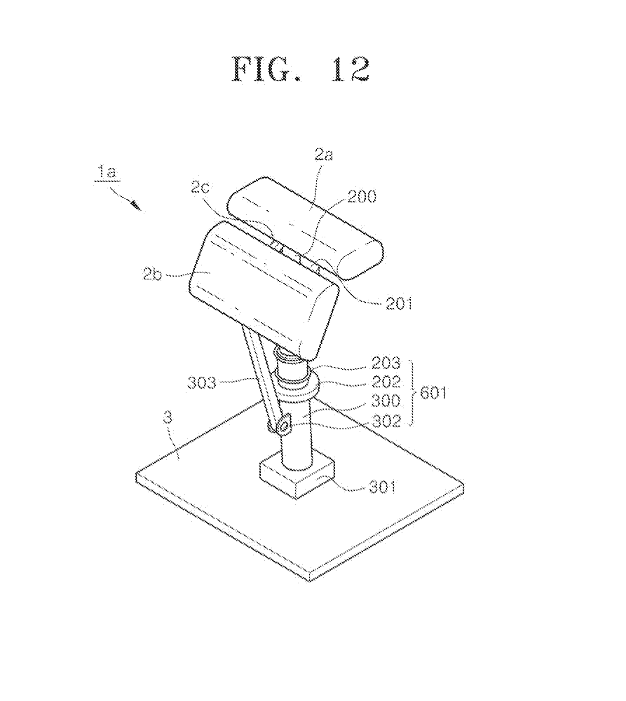

FIG. 12 is a perspective view of a chair 1a for easy-sitting and easy-rising motions, according to another embodiment of the present invention. Referring to FIG. 12, a main seat plate 2a and an auxiliary seat plate 2b are connected to each other in a back-and-forth direction, and the main seat plate 2a is supported on the base 3 by an extensible support unit 601 that is disposed under the main seat plate 2a.

The main seat plate 2a and the auxiliary seat plate 2b are connected to each other by a connection member 2c such that positions of the main seat plate 2a and the auxiliary seat plate 2b and a distance between the main seat plate 2a and the auxiliary seat plate 2b may be slightly changed, and an upper end portion of the extensible support unit 601 is fixed to a bottom surface of the main seat plate 2a and a lower end portion of the extensible support unit 601 is fixed to the base 3. Since the other end of the auxiliary seat plate 2b is connected to an auxiliary plate support connection bar 303 that is pivotably fixed to the extensible support unit 601, the auxiliary seat plate 2b may pivot by a predetermined angle about a hinge connection unit 302.

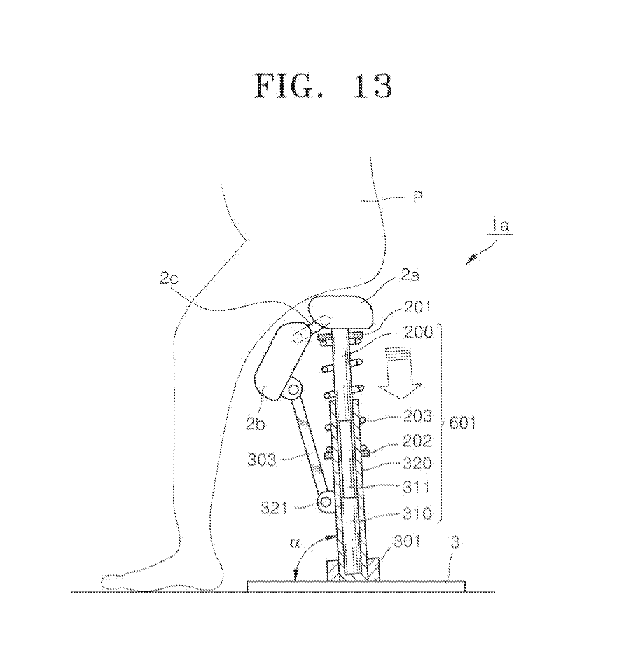

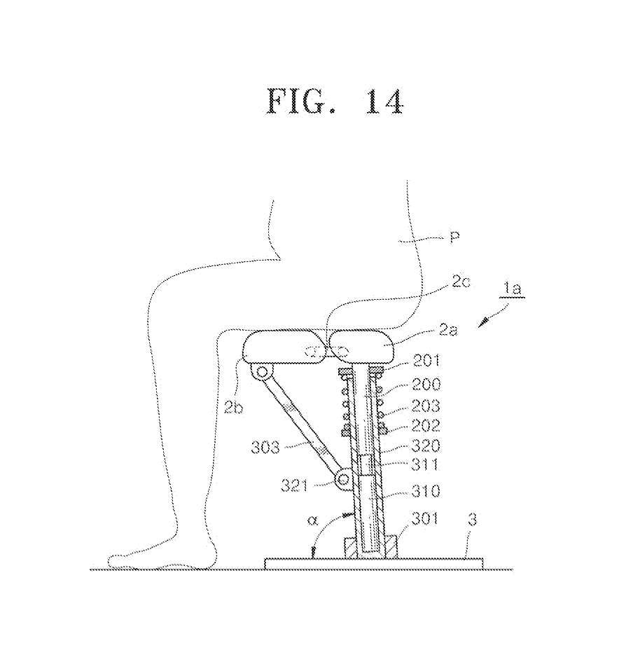

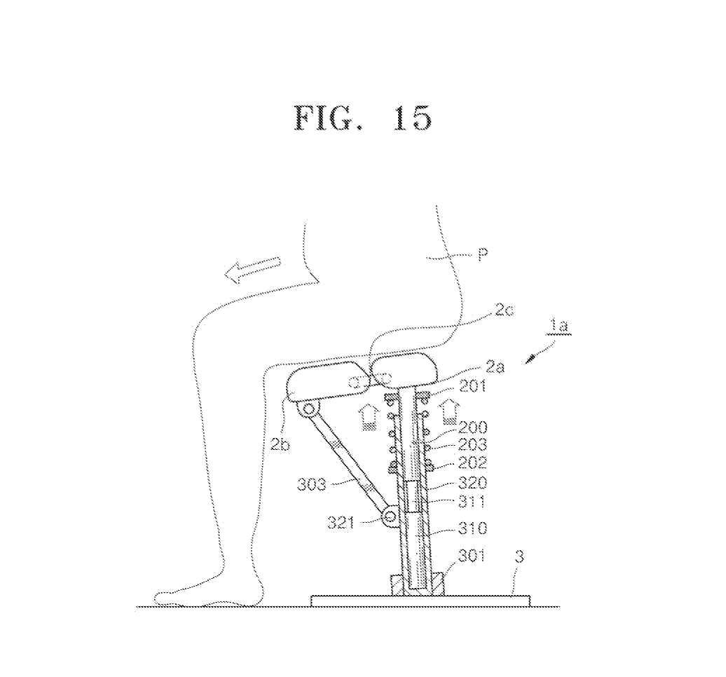

FIGS. 13 through 15 are side views of the chair 1a of FIG. 12. FIG. 13 illustrates that the user P does not completely sit on the chair 1a, FIG. 14 illustrates that the user completely sits on the chair 1a and the main seat plate 2a and the auxiliary seat plate 2b are lowered, and FIG. 15 illustrates that when the user P tries to rise from the chair 1a, the shock absorber 310 extends due to an elastic force of a spring 203.

Referring to FIGS. 12 and 13, the extensible support unit 601 that erects from the base 3 includes an outer container 300, a shock absorber 310 provided in the outer container 300, and a spindle 200 that is connected to an upper portion of the shock absorber 310. Since the spring 203 is wound around the spindle 200 and an upper spring fixing protrusion 201 is provided at a predetermined position of the spindle 200, the spindle 200 is provided with an elastic force of the spring 203 to maintain an extended state. A lower spring fixing protrusion 202 is provided at a predetermined position of an outer circumferential surface of the outer container 300.

When the user P tries to sit on the main seat plate 2a and the auxiliary seat plate 2b by applying his/her weight to the main seat plate 2a and the auxiliary seat plate 2b, the spindle 200 overcomes an elastic force of the spring 203 and is inserted into the outer container 300. In this case, since the shock absorber 310 slowly compresses by absorbing an impact, the spindle 200 is slowly inserted into the outer container 300.

FIG. 14 is a side view of the chair 1a of FIG. 12, illustrating that the chair 1a is completely lowered. In this case, the spring 203 is pressurized to the maximum between the upper spring fixing protrusion 201 and the lower spring fixing protrusion 202, and the shock absorber 310 compresses to a smallest length. Although the auxiliary seat plate 2b is inclined at about 30 to 60° forward before the main seat plate 2a is lowered as shown in FIG. 13, the auxiliary seat plate 2b is horizontal to be at almost the same plane as that of the main seat plate 2a when the main seat plate 2a is completely lowered as shown in FIG. 14.

Also, as shown in FIGS. 13 and 14, since a lower end portion of the auxiliary seat plate connection support bar 303 that supports the auxiliary seat plate 2b is fixed to and is pivotably supported by a hinge connection unit 321 of the outer container 300, the auxiliary seat plate connection support bar 303 guides a movement of the auxiliary seat plate 2b.

As shown in FIG. 15, when the user P sitting on the chair 1a tries to rise by slightly shifting his/her weight forward or slightly raising his/her hips, since the spindle 200 is moved out of the outer container 300 due to an elastic force of the spring 203, the main seat plate 2a is forced to be raised. Due to such a mechanism, even when the user P flops down into the chair 1a, the chair 1a may help the user P to slowly and safely sit on the chair 1a, and when the user P tries to rise from the chair 1a by shifting his/her weight forward or slightly raising his/her hips, the chair 1 may help the user P to easily and comfortably rise from the chair 1a without much difficulty because the main seat plate 2a is forced to be raised.

Referring to FIGS. 13 and 14, in order to help the user P to more easily sit on and rise from the chair 1a, an angle α between the extensible support unit 601 and the base 3, that is, between the outer container 300 and the base 3, may be slightly less than the right angle (90°). Preferably, the outer container 300 may be inclined toward the auxiliary seat plate 2b to have an angle of about 80° to 89° between the outer container 300 and the base 3, and more preferably, the outer container 300 may be inclined to have an angle of about 84° to 87°.

In FIGS. 12 through 15, reference numeral 301 denotes a support flange that fixes the outer container 300 to the base 3.

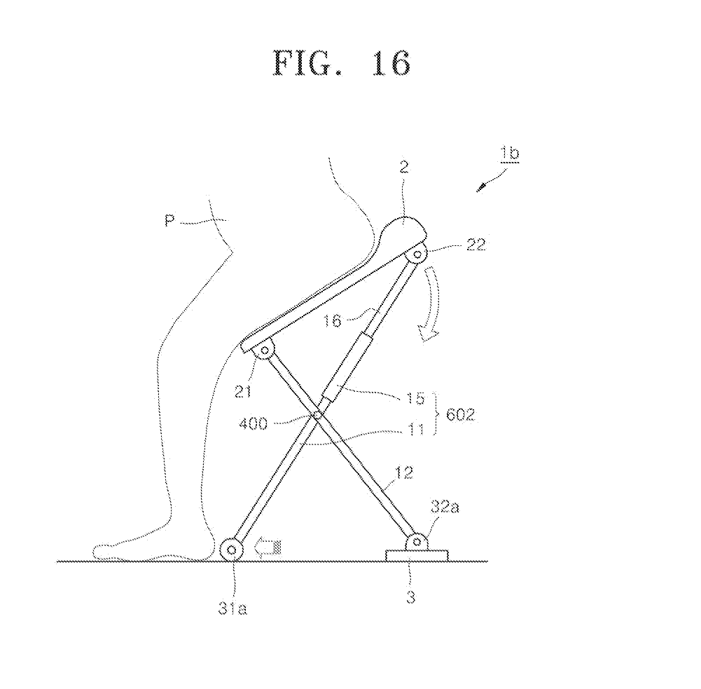

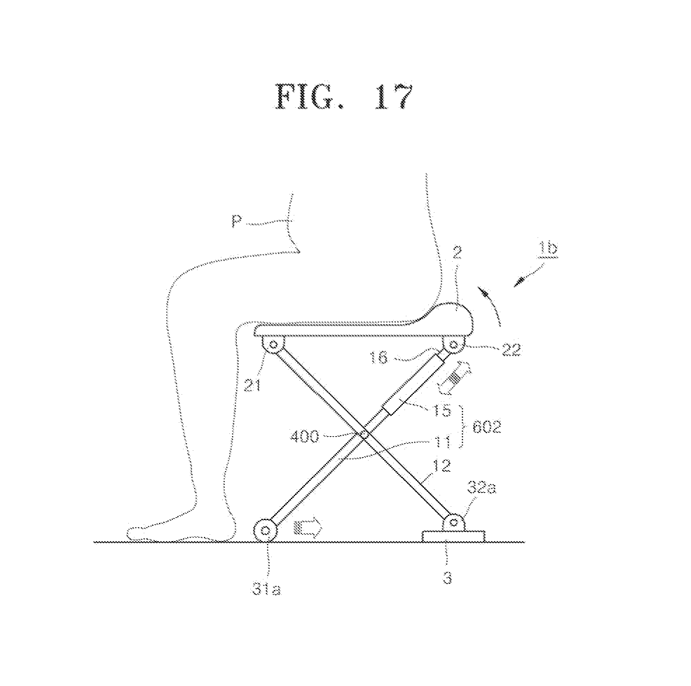

FIGS. 16 and 17 are side views of a chair 1b for easy-sitting and easy-rising motions, according to another embodiment of the present invention. Referring to FIGS. 16 and 17, the first support rod 11 and the second support rod 12 which support the chair 1b in an X shape are fixedly supported by a rod coupling pin 400, and a lower end portion of the first support rod 11 may be moved by using a wheel 31a.

Although the chair 1b of FIGS. 16 and 17 is similar to the chair 1 of FIG. 1, the chair 1b is different from the chair 1 in that the guide rod 13 is omitted, the movement grooves 11a and 11b (see FIGS. 1 through 4) are not respectively formed in the first support rod 11 and the second support rod 12, and the first support rod 11 and the second support rod 12 are coupled to each other by the rod coupling pin 400 at only one position.

Referring to FIGS. 16 and 17, a portion of a member (that is, the second support rod 12) for supporting a front portion of the seat plate 2 of the chair 1b which contacts the ground is fixed in position, and a portion of a member (that is, the first support rod 11) for supporting a rear portion of the seat plate 2 of the chair 1b which contacts the ground may move back and forth due to the wheel 31a.

When the first support rod 11 and the second support rod 12 are coupled to each other by crossing each other in an X shape, in order not to change positions of the rods 11 and 12 like the rods 12a and 13b (see FIGS. 1 through 4) and in order to vertically move the seat plate 2, a distance between lower end portions of the first support rod 11 and the second support rod 12 has to be changed as shown in FIGS. 16 and 17. That is, when the seat plate 2 is raised, the wheel 31a formed on the lower end portion of the first support rod 11 is closer to the base 3 formed on the lower end portion of the second support rod 12 (see FIG. 16), and when the seat plate 2 is lowered, a distance between the wheel 31a formed on the lower end portion of the first support rod 11 and the base 3 of the lower end portion of the second support rod 12 is increased.

Reference numeral 32a in FIGS. 16 and 17 denotes a lower connection hinge for connecting the second support rod 12 to the base 3.

Except that positions of the first support rod 11 and the second support rod 12 are fixed to one position by the rod coupling pin 400 in FIGS. 16 and 17, since other elements are the same as those in FIGS. 1 through 4, an explanation thereof will not be given.

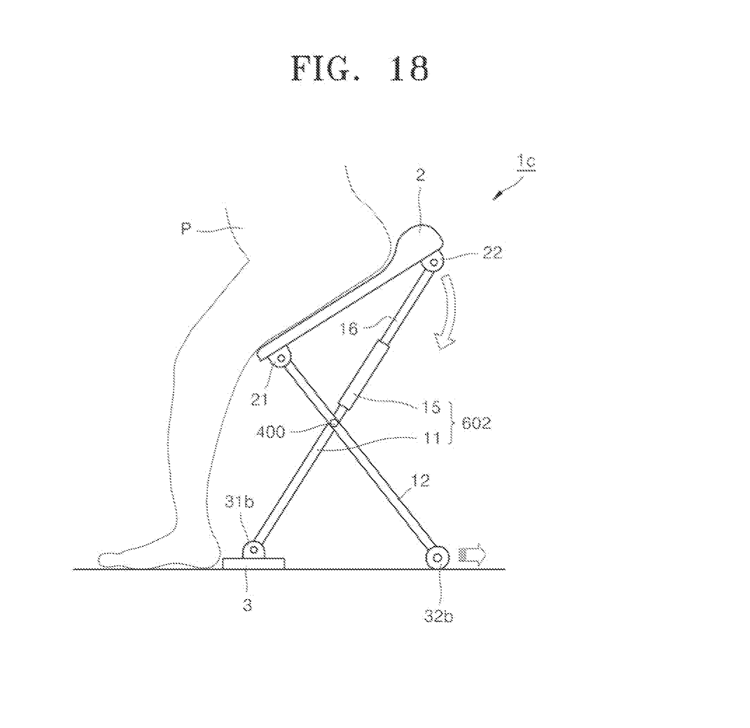

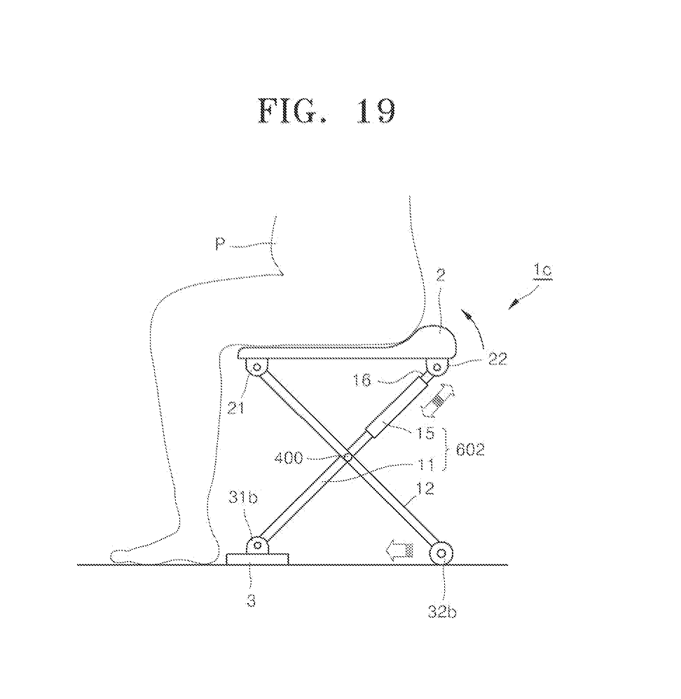

FIGS. 18 and 19 are side views of a chair 1c for easy-sitting and easy-rising motions, according to another embodiment of the present invention. Referring to FIGS. 18 and 19, the first support rod 11 and the second support rod 12 which support the chair 1c in an X shape are fixedly supported by the rod coupling pin 400, and a lower end portion of the second support rod 12 may be moved by using a wheel 32b.

Unlike in FIGS. 16 and 17, in FIGS. 18 and 19, a lower portion of the first support rod 11 on which the shock absorber 15 is provided is fixed by the base 3, and the lower end portion of the second support rod 12 may be moved back and forth due to the wheel 32b.

In FIGS. 18 and 19, reference numeral 31b denotes a lower connection hinge for connecting the first support rod 11 to the base 3.

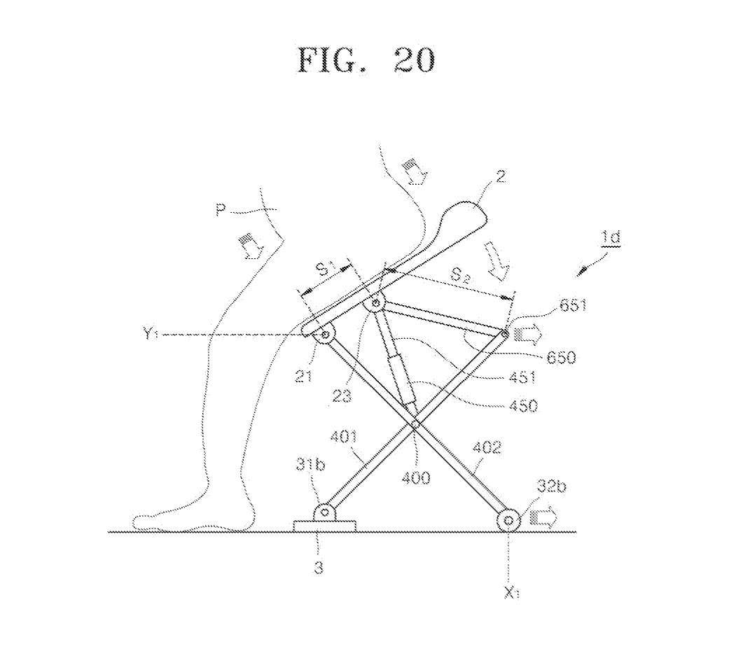

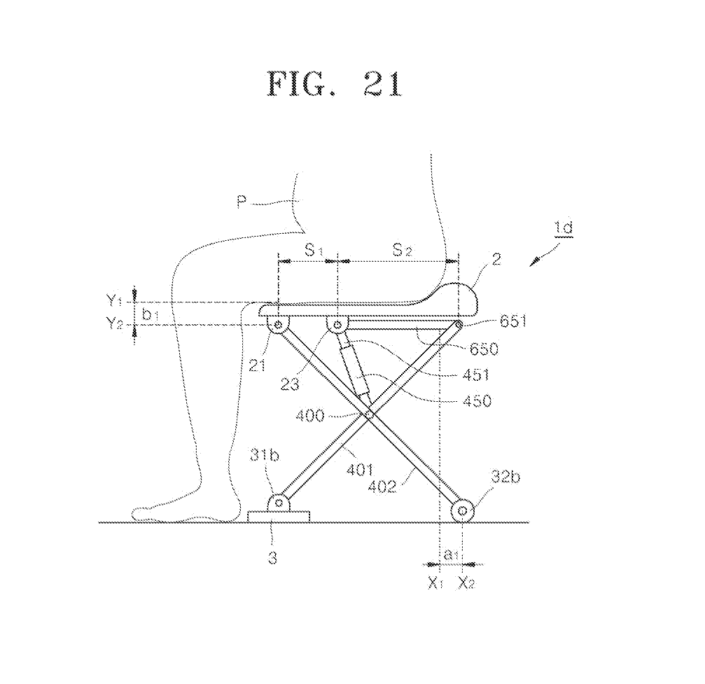

FIGS. 20 and 21 are side views for explaining an operation of a chair 1d for easy-sitting and easy-rising motions, according to another embodiment of the present invention. Referring to FIGS. 20 and 21, a first support rod 401 and a second support rod 402 cross each other in an X shape under the seat plate 2 of the chair 1d. Unlike in the previous embodiments, an upper end portion of the first support rod 401 is not directly coupled to the seat plate 2 of the chair 1d. Instead, one end portion of a connection rod 650 is pivotably coupled by a coupling pin 651 to the upper end portion of the first support rod 401, and the other end portion of the connection rod 650 is pivotably coupled by a third upper connection hinge 23 formed on the seat plate 2 of the chair 1d.

Portions of the first support rod 401 and the second support rod 402 which cross each other are pivotably coupled to each other by the rod coupling pin 400. A shock absorber 450 is provided between the third upper connection hinge 23 and the rod coupling pin 400. When the user P sits on the chair 1d, the shock absorber 450 absorbs an impact and slowly compresses, and thus the seat plate 2 is lowered to change from being inclined to being horizontal. When the user P rises from the chair 1d, a spring which is not shown but is provided around a piston rod 451 of the shock absorber 450 exerts an elastic force to slowly extend, and thus the seat plate 2 is slowly raised to change from being horizontal to being inclined forward.

As such, since the third upper connection hinge 23 applies a force to the shock absorber 450 and is also provided with a force from the shock absorber 450, the third upper connection hinge 23 may function as a point where a force needed to lower and raise the chair 1d is applied.

The third upper connection hinge 23 is provided at a point between a front end and a rear end, instead of a rear end portion, of the seat plate 2. Although the third upper connection hinge 23 may be located at any position between the front end and the rear end of the seat plate 2, in order to smoothly raise and lower the chair 1d and reduce the amount of vertical movement of the seat plate 2 and the amount of movement of the first and second support rods 401 and 402, the third upper connection hinge 23 may be located closer to the front end or the rear end of the seat plate 2. That is, in FIG. 20, a distance S₁ between the first upper connection hinge 21 and the third upper connection hinge 23 may be less than a length S₂ of the connection rod 650, and particularly, may be about 40 to 60% of the length S₂.

Referring to FIGS. 20 and 21, since a lower portion of the first support rod 401 is pivotably fixed to the base 3 by a lower connection hinge 31b, the lower end portion of the first support rod 401 is fixed to the ground. However, since the wheel 32b is provided on a lower end portion of the second support rod 402, when the seat plate 2 is lowered, the lower end portion of the second support rod 402 moves backward (see FIG. 21). That is, when the seat plate 2 of the chair 1d is raised to the maximum, the wheel 32b of the second support rod 402 is located at a position X₁ (see FIG. 20), and when the seat plate 2 is lowered to the maximum, the wheel 32b of the second support rod 402 moves by a distance of a₁ to be located at a position X₂ (see FIG. 21).

When the seat plate 2 of the chair 1d is raised to the maximum, the first upper connection hinge 21 provided on a front end portion of the seat plate 2 is located at a position Y₁ (see FIG. 20), and when the seat plate 2 is lowered to the maximum, the first upper connection hinge 21 moves by a distance of b₁ to be located at a position Y₂ (see FIG. 21).

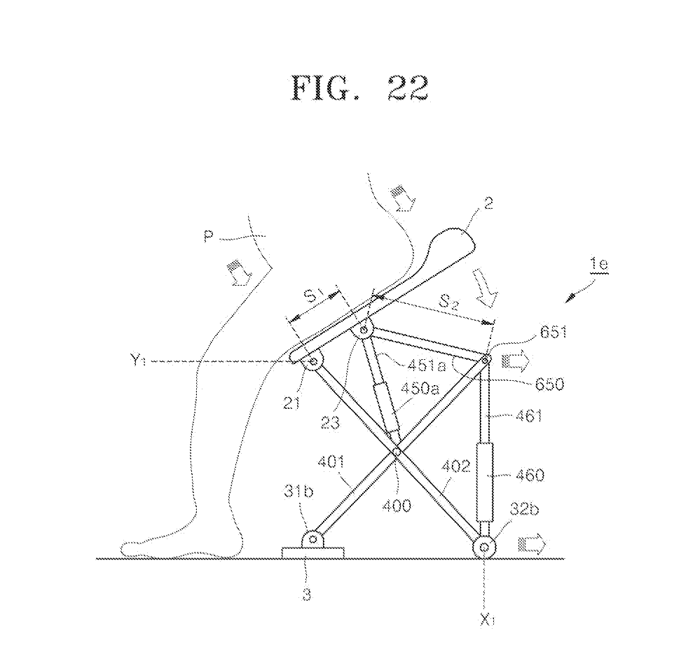

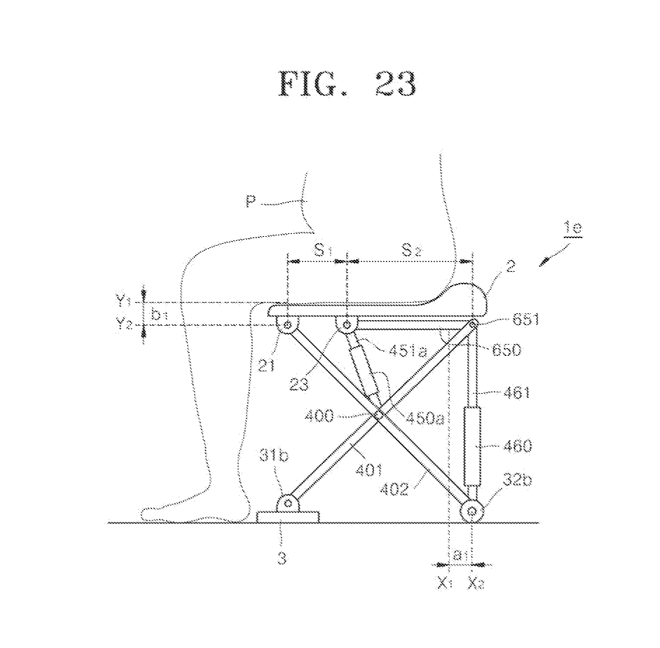

FIGS. 22 and 23 are side views for explaining an operation of a chair 1e for easy-sitting and easy-rising motions, according to another embodiment of the present invention. When compared with FIGS. 20 and 21, in FIGS. 22 and 23, a second shock absorber 460 is further provided between a lower end portion of the second support rod 402 and an upper end portion of the first support rod 401. The second shock absorber 460 compensates for an operation of a first shock absorber 450a that is provided between the third upper connection hinge 23 and the rod coupling pin 400. As such, when the first and second shock absorbers 450a and 460 are provided, the chair 1e is expected to be more smoothly and stably lowered and raised.

In FIGS. 22 and 23, reference numeral 451a denotes a piston rod of the first shock absorber 450a.

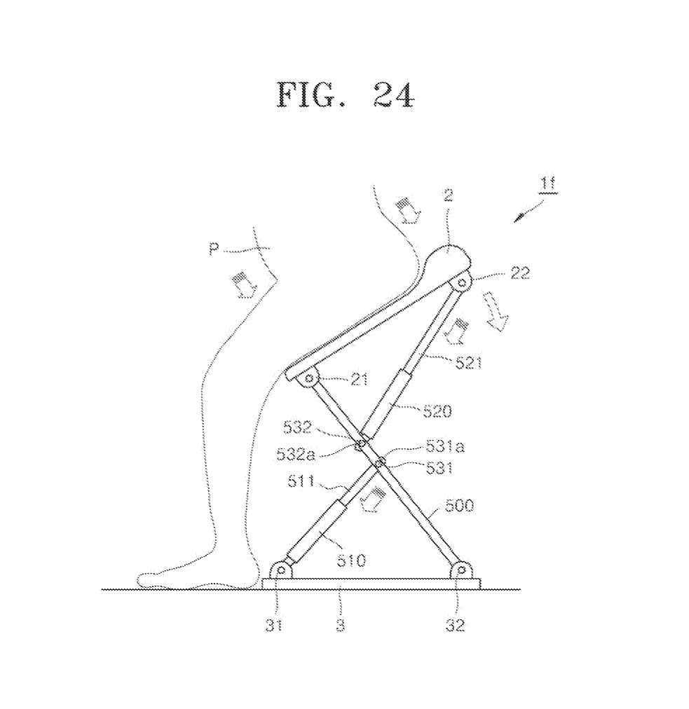

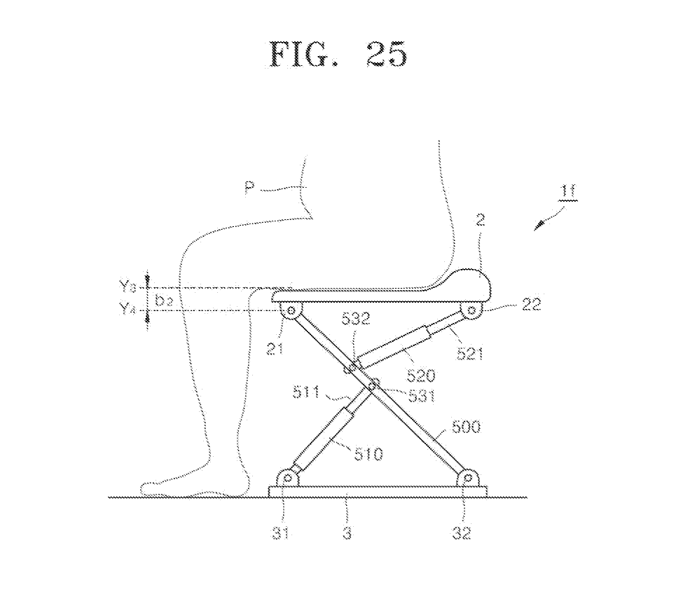

FIGS. 24 and 25 are side views for explaining an operation of a chair 1f for easy-sitting and easy-rising motions, according to another embodiment of the present invention. Referring to FIGS. 24 and 25, an upper end portion of a basic support rod 500 is pivotably fixed to a front portion of the seat plate 2 of the chair 1f, and a lower end portion of the basic support rod 500 is pivotably fixed to the base 3 under a rear portion of the seat plate 2.

A first shock absorber 510 and a second shock absorber 520 are coupled to the basic support rod 500. The first shock absorber 510 is disposed between the base 3 and the basic support rod 500, and an upper end portion of the first shock absorber 510 is pivotably fixed by a first rod coupling pin 531 at a first coupling point 531a on the basic support rod 500 and a lower end portion of the first shock absorber 510 is pivotably fixed to the first lower connection hinge 31 provided on the base 3.

The second shock absorber 520 is provided between the seat plate 2 of the chair 1f and the basic support rod 500, and an upper end portion of the second shock absorber 520 is pivotably fixed to the second upper connection hinge 22 provided on the rear portion of the seat plate 2 of the chair 1f and a lower end portion of the second shock absorber 520 is pivotably fixed by a second rod coupling pin 532 at a second coupling point 532a on the basic support rod 500.

Even when the seat plate 2 of the chair 1f is raised or lowered, positions of portions contacting the ground under the seat plate 2 are not changed due to the base 3. Only the seat plate 2 is lowered by moving slightly forward and is raised. That is, when the seat plate 2 of the chair 1f is raised to the maximum, the first upper connection hinge 21 of the seat plate 2 of the chair 1f is located at a position Y₃ (see FIG. 25), and when the seat plate 2 of the chair 1f is lowered to the maximum, the first upper connection hinge 21 of the seat plate 2 moves by a distance b₂ to be located at a position Y₄ (see FIG. 25).

Although two shock absorbers 510 and 520, that is, the first coupling point 531a and the second coupling point 532a, are separately disposed on the basic support rod 500 in FIGS. 24 and 25, the coupling points 531a and 532a may be the same. That is, the upper end portion of the first shock absorber 510 and the lower end portion of the second shock absorber 520 may be coupled to each other at one point on the basic support rod 500.

In addition, although a fixed position (that is, the first coupling point 531a) of the first shock absorber 510 is lower in position than a fixed position (that is, the second coupling point 532a) of the second shock absorber 520 on the basic support rod 500 in FIGS. 24 and 25, the first coupling point 531a for coupling the first shock absorber 510 to the basic support rod 500 may be higher in position than the second coupling point 532a for coupling the second shock absorber 510 to the basic support rod 500.

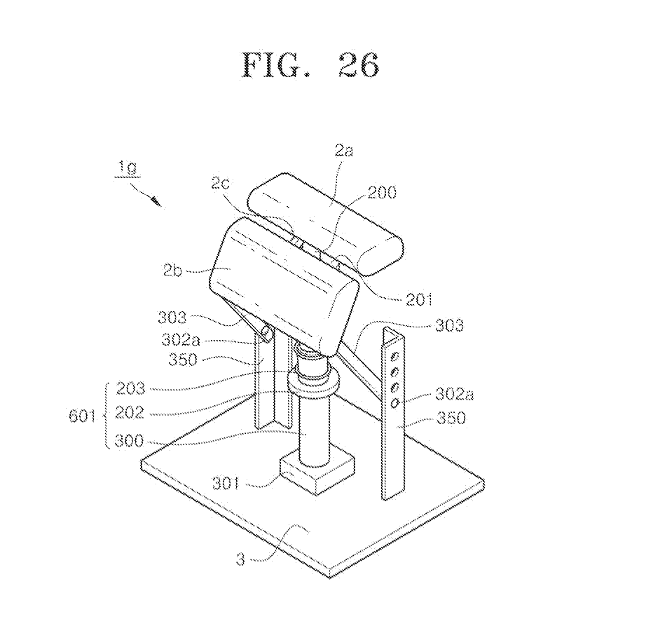

FIG. 26 is a perspective view of a chair 1g for easy-sitting and easy-rising motions, according to another embodiment of the present invention, which is a modification of the chair 1a of FIG. 12.

When compared with the chair 1a of FIG. 12, the auxiliary seat plate support connection bar 303 connected to an auxiliary seat plate 2b is pivotably fixed to a vertical support 350 that erects from the base 3, without being fixed to the outer container 300 of the extensible support unit 601. In FIG. 26, since the auxiliary seat plate 2b is supported on both left and right sides by the vertical supports 350 due to the auxiliary seat plate support connection bars 303, the chair 1g may be more stably vertically raised and lowered. In FIG. 26, reference numeral 302a denotes a coupling pin that pivotably fixes a lower end portion of the auxiliary seat plate support connection bar 303 to the vertical support 350.

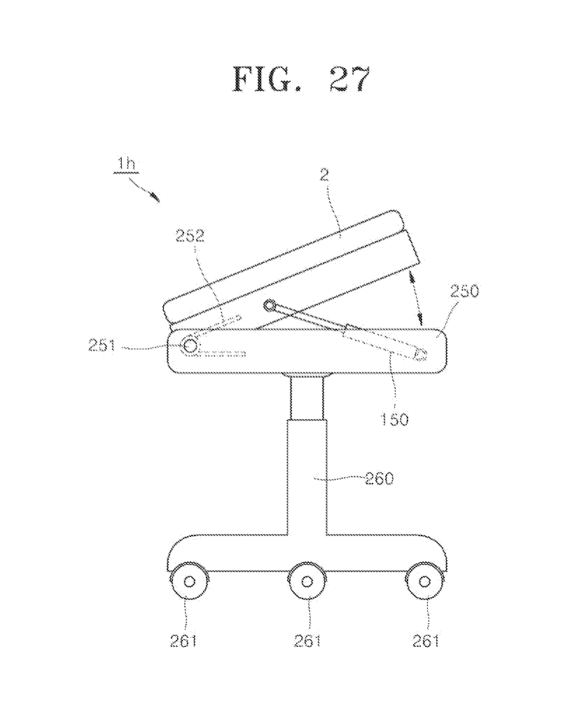

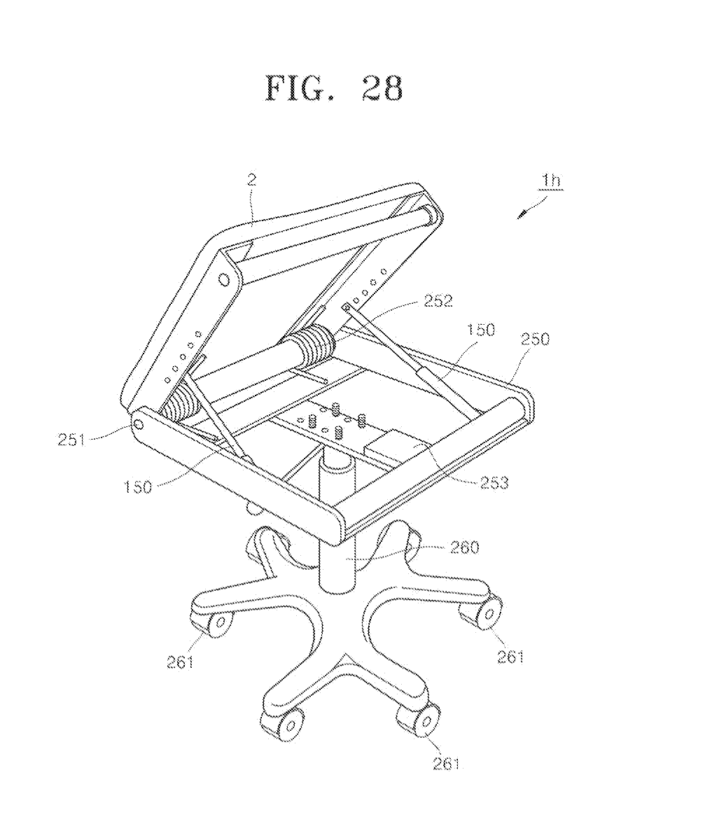

FIG. 27 is a side view of a chair 1h for easy-sitting and easy-rising motions, according to another embodiment of the present invention. FIG. 28 is a side rear perspective view of the chair 1h of FIG. 27.

Referring to FIG. 27, the chair 1h includes the seat plate 2 on which hips of the user P may be placed, and a seat plate support 250 that pivotably supports the seat plate 2 within a predetermined range of angles. A lower support unit 260 and wheels 261 are provided under the seat plate support 250. Since the seat plate 2 and the seat plate support 250 are coupled to each other by a rotational shaft pin 251 at front end portions thereof and a torsion spring 252 disposed between the seat plate 2 and the seat plate support 250 exerts an elastic force, the seat plate 2 may be inclined at a predetermined angle with respect to the seat plate support 250. Since the shock absorber 150 is also provided between the seat plate 2 and the seat plate support 250, the shock absorber 150 enables the seat plate 2 to be slowly lowered.

Referring to FIG. 28, since a cushion 253 is provided on a rear end portion of the seat plate support 250, when the seat plate 2 is lowered to almost contact the seat plate support 250, the cushion 253 absorbs an impact.

When the user P sits on the chair 1h of FIG. 27, the torsion spring 252 and the shock absorber 150 are coupled to each other and the seat plate 2 is slowly lowered to be horizontal by changing its angle, and when the user P shifts his/her weight forward to rise from the chair 1h, he/she may easily rise due to an elastic force of the torsion spring 252.

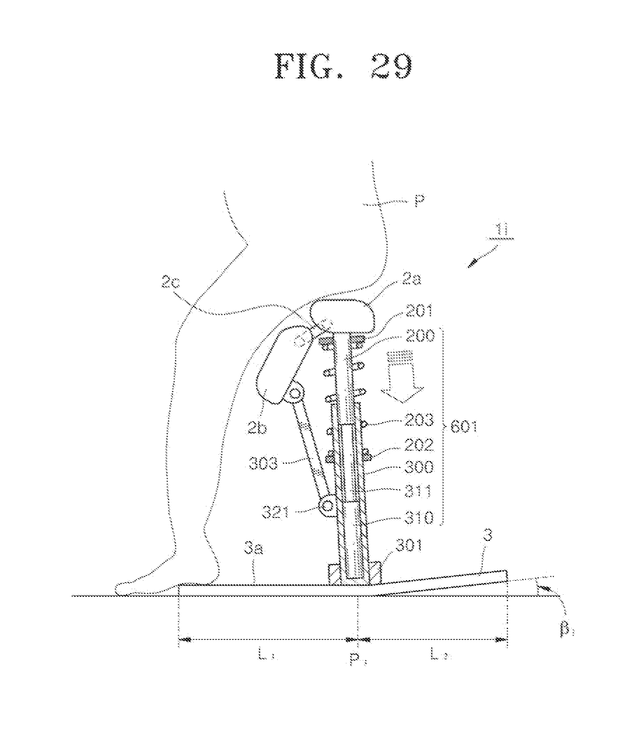

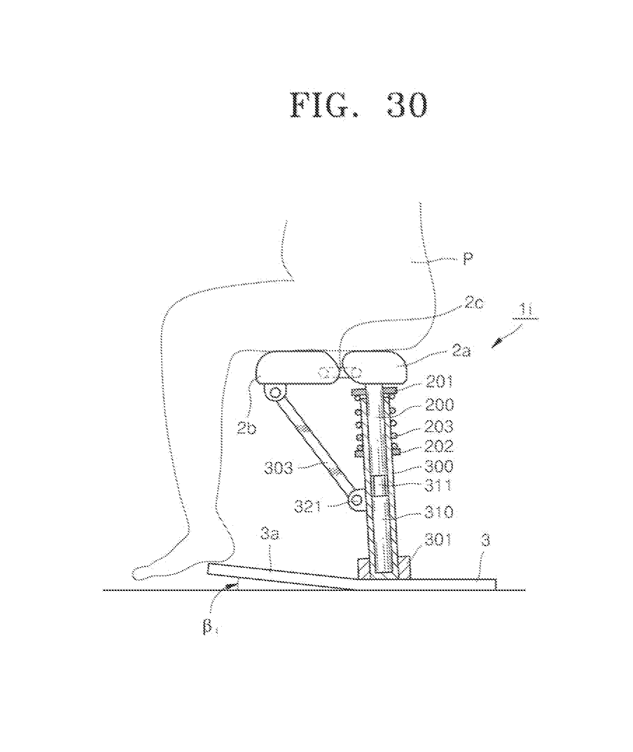

FIGS. 29 and 30 are side views for explaining an operation of a chair 1i for easy-sitting and easy-rising motions, according to another embodiment of the present invention.

When compared with the chair 1a of FIG. 12, in FIGS. 29 and 30, a front end portion 3a of the base 3 is inclined upward at a predetermined angle of β₁. As such, since the front end portion 3a of the base 3 is inclined upward, since the chair 1i is slightly inclined forward as shown in FIG. 29 before the user P sits on the chair 1i, when the user P tries to sit on the chair 1i, he/she may easily put his/her hips on the main seat plate 2a and the auxiliary seat plate 2b. Also, when the user P applies his/her weight to the main seat plate 2a and the auxiliary seat plate 2b by inclining the chair 1i forward, the main seat plate 2a and the auxiliary seat plate 2b may be easily lowered by overcoming resistances of the spring 203 and the shock absorber 310.

FIG. 30 illustrates that the user P completely sits on the chair 1i, and in this case, the front end portion 3a of the base 3 is inclined upward. Accordingly, like a rocking chair, when the user sits on the chair 1i, the chair 1i may rock at a predetermined angle as the center of the chair 1i changes from front to back, and when the user P rises, the chair 1i may rock at a predetermined angle as the center of the chair 1i changes from back to front. Also, when a seat back and/or an arm rest is added to the chair 1i, people will more comfortably use the chair 1i.

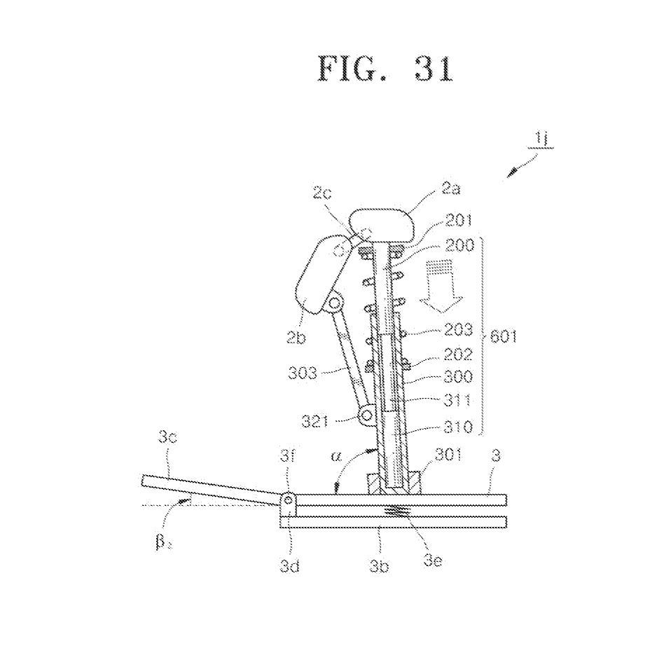

FIGS. 31 through 33 are side views for explaining an operation of a chair 1j for easy-sitting and easy-rising motions, according to another embodiment of the present invention. When compared with the chair 1a of FIG. 12, in FIGS. 31 through 33, another bottom plate 3b is provided under the base 3 and the base 3 is supported to pivot within a predetermined range of angles by a rotational shaft pin 3f of a rotational support unit 3d that is provided on a front end portion of the bottom surface 3b. Also, a front end portion 3c of the base 3 is inclined upward at a predetermined angle of β₂ with respect to the base 3.

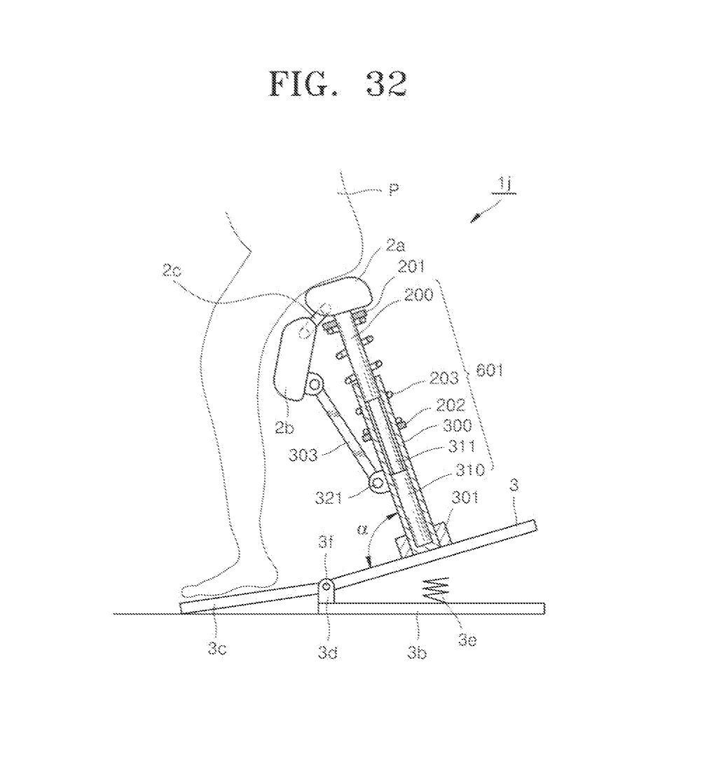

FIG. 31 illustrates that the chair 1j is in a normal state. When the user P pushes the front end portion 3c of the base 3 with a foot to sit on the chair 1j, the base 3 pivots forward and elements of the chair 1j other than the bottom surface 3b are inclined forward (see FIG. 32). When the main seat plate 2a and the auxiliary seat plate 2b of the chair 1j are inclined forward from the state of FIG. 32, since the user P may more easily put body parts such as hips and thighs on the main seat plate 2a and the auxiliary seat plate 2b, the chair 1j may be more easily used.

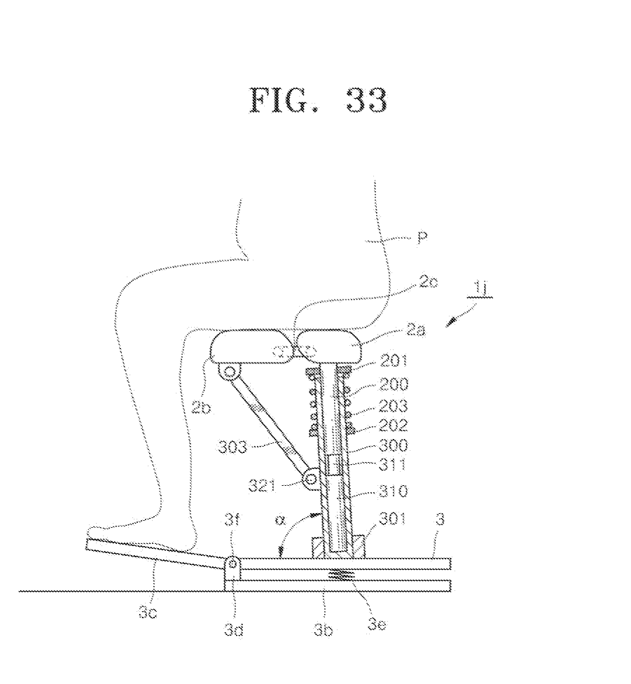

After the user P completely sits on the chair 1j by applying his/her weight, the spring 203 and the shock absorber 310 are pressurized due to the weight. Since the center of gravity of the chair 1j is completely located at a rear side, the front end portion 3c of the base 3 is inclined upward (see FIG. 33).

The shock absorbers 15, 450, 451a, 460, 510, and 520 may be the same as the shock absorbers 15, 15a, and 15b of FIGS. 5 through 10 or shock absorbers having other structures and mechanisms. Accordingly, various types of shock absorbers other than the shock absorbers described in the above embodiments may be used in the present invention.

Although a spring is not mounted outside a shock absorber in FIGS. 16 through 25, a shock absorber having a separate spring mounted around a piston rod outside thereof may be used.

In FIGS. 1 through 33, without using separate external power (e.g., electric power, hydraulic pressure, or gas pressure), when a user tries to sit on a chair by applying a weight to a seat plate or tries to rise from the chair by slightly removing a weight from the chair, the seat plate is lowered and raised by naturally changing its angle by using a shock absorber. However, the seat plate may be lowered and raised by using external power of a motor cylinder (e.g., a hydraulic cylinder or a pneumatic cylinder) instead of the shock absorber. Accordingly, the chair may be lowered/raised by using the motor cylinder as well as the shock absorber described in any of the embodiments without departing from the scope of the present invention.

### INDUSTRIAL APPLICABILITY

Structures and operations have been described in detail with reference to embodiments of the present invention. Since a chair for easy-sitting and easy-rising motions of the present invention may help the old, the weak, the disabled, and patients who have bad waists, hips, or knees to easily sit on and rise from the chair without putting stress on the waists, the hips, or the knees, the chair is expected to improve the welfare of the old, the weak, the disabled, and patients in daily life.

In particular, when the chair for easy-sitting and easy-rising motions according to the present invention is applied to a toilet seat as well as a general chair, the chair is expected to greatly help patients, the old, the weak, and the disabled to more easily and safely use a toilet. It is very difficult for people who are physically challenged due to physical disabilities or various diseases to sit on and rise from a toilet seat by themselves and it is not easy for them to get others' help in toilets. When the chair for easy-sitting and easy-rising motions according to the present invention is applied to a toilet seat, since a user does not flop down into the toilet seat, he/she may easily and safely sit on the toilet seat without putting stress on joints. Even when the user rises from the chair, since he/she may rise from the chair more easily than from a conventional toilet seat, the disabled, the old, the weak, or patients may use the toilet seat without others' help in daily life.

Accordingly, since the chair for easy-sitting and easy-rising motions of the present invention helps physically challenged people to more comfortably enjoy their life, the chair is expected to greatly improve the welfare of the old, the weak, patients, and the disabled in daily life in the future.

1. A chair for easy-sitting and easy-rising motions which, when a user's weight is applied to a seat plate, may help the user to easily and safely sit on the chair by allowing the seat plate to be slowly and smoothly lowered by changing its angle as angles of thighs and hips of the user vary by using a shock absorber and a spring or a motor cylinder, or when the user tries to rise from the chair, may help the user to easily and safely rise from the chair by allowing the seat plate to be raised by changing its angle.

2. A chair for easy-sitting and easy-rising motions, the chair comprising:
a seat plate 2 on which a user's hips may be placed;
a base 3 that is disposed under the seat plate 2 to contact the ground and supports a structure of the chair;
an extensible support unit 600 whose upper end portion is pivotably fixed to a rear portion of the seat plate 2 and whose lower end portion is pivotably fixed to a front portion of the base 3;
a second support rod 12 whose upper end portion is pivotably fixed to a front portion of the seat plate 2 and lower end portion is pivotably fixed to a rear portion of the base 3; and
a guide rod 13 whose lower end portion is fixed to the base 3, and that is disposed between the extensible support unit 600 and the second support rod 12 and guides pivotal movements of the extensible support unit 600 and the second support rod.

3. The chair of claim 2, wherein the extensible support unit 600 comprises a first support rod 11 whose lower end portion is pivotably fixed to the front portion of the base 3, and a shock absorber 15 whose one end is coupled to an upper end portion of the first support rod 11,
wherein the other end of the shock absorber 15 is pivotably fixed to the rear portion of the seat plate 2.

4. The chair of claim 2, wherein the extensible support unit 600 comprises a first support rod 11 whose lower end portion is pivotably fixed to the front portion of the base 3, and a motor cylinder whose one end is coupled to an upper end portion of the first support rod 11,
wherein the other end of the motor cylinder is pivotably fixed to the rear portion of the seat plate 2.

5. The chair of claim 3, wherein a first movement groove 11a is partially formed as a long groove in the first support rod 11 in a longitudinal direction of the first support rod 11, a second movement groove 12a is partially formed as a long groove in the second support rod 12 in a longitudinal direction of the second support rod 12, and a guide long groove 13a is partially formed in the guide rod 13 in a longitudinal direction of the guide rod 13,
wherein a support rod connection pin 17 passes through the first movement groove 11a, the second movement groove 12a, and the guide long groove 13a, such that the first support rod 11, the second support rod 12 and the guide rod 13 are coupled while the positions of the first support rod 11, the second support rod 12 and the guide rod 13 may be changed.

6. The chair of claim 3, wherein the shock absorber 15 comprises:
an outer housing 155 that is disposed between the first support rod 11 and the rear portion of the seat plate 2;
an inner cylinder 160 that is disposed in the outer housing 155;
a piston rod 16 whose piston head 16a is movable in the inner cylinder 160 and end portion opposite to a portion connected to the piston head 16a is connected to the seat plate 2;
a spring 158 that is provided in the inner cylinder 160 and exerts an elastic force to push the piston head 16a,
first orifices 151 that are formed in a lower end portion of the inner cylinder 160;
second orifices 152 that are formed between the outer housing 155 and the inner cylinder 160;
third orifices 153 that are formed in an upper end portion of the inner cylinder 160; and
a working fluid 157 that fills in an inner space of the outer housing 155,
wherein when a user sits on the seat plate 2, the shock absorber 15 slowly compresses and when the user rises from the seat plate 2, the shock absorber 15 slowly extends due to an elastic force of the spring 158.

7. The chair of claim 3, wherein the shock absorber 15 comprises:
an outer housing 155 that is disposed between the first support rod 11 and the rear portion of the seat plate 2;
an inner cylinder 160 that is disposed in the outer housing 155;
a piston rod 16 whose piston head 16a is movable in the inner cylinder 160 and end portion opposite to a portion connected to the head is connected to the seat plate 2;
a spring fixing protrusion 158b that is formed on the piston rod 16;
an outer spring 158a that is disposed between an upper cover 155b of the outer housing 155 and the spring fixing protrusion 158b to surround the piston rod 16;
first orifices 151 that are formed in a lower end portion of the inner cylinder 160;
second orifices 152 that are formed between the outer housing 155 and the inner cylinder 160;
third orifices 153 that are formed in an upper end portion of the inner cylinder 160; and
a working fluid 157 that fills in an inner space of the outer housing 155,
wherein when a user sits on the seat plate 2, the shock absorber 15 slowly compresses and when the user rises from the seat plate 2, the shock absorber 15 extends due to an elastic force of the outer spring 158a.

8. The chair of claim 6, wherein an adjustment block 171 is provided adjacent to at least one of the first through third orifices 151, 152, and 153 of the shock absorber 15, and an adjustment knob 170 that may change a position of the adjustment block 171 is provided on the outer housing 155,
wherein the adjustment block 171 may partially or entirely open or close at least one of the first through third orifices 151, 152, and 153 by manipulating the adjustment knob 170, to thus adjust an operation speed of the extensible support unit 600 or fix the extensible support unit 600 to its current position.

9. A chair for easy-sitting and easy-rising motions, the chair comprising:
a main seat plate 2a on which a user's hips may be placed;
an auxiliary seat plate 2b that is disposed in front of the main seat plate 2a and is connected via a connection member 2c to the main seat plate 2a;
a base that is disposed under the main seat plate 2a and the auxiliary seat plate 2b to contact the ground and supports a structure of the chair;
an extensible support unit 601 whose upper end portion is fixed to a bottom surface of the main seat plate 2a and lower end portion is fixed to the base 3 and
an auxiliary seat plate support connection bar 303 whose end is pivotably fixed to the auxiliary seat plate 2b and the other end is pivotably fixed to the extensible support unit 601.

10. The chair of claim 9, wherein the extensible support unit 601 comprises:
an outer container 300 that fixedly erects from the base 3;
a shock absorber 310 that is provided in the outer container 300;
a spindle 200 whose lower end portion is connected to the shock absorber 310 in the outer container 300 and upper end portion is fixed to the bottom surface of the main seat plate 2a; and
a spring 203 that surrounds the spindle 200,
wherein the main seat plate 2a and the auxiliary seat plate 2b which are connected to each other are vertically movable;
wherein when the user sits on the main seat plate 2a and the auxiliary seat plate 2b, the shock absorber 310 slowly compresses and when the user rises from the main seat plate 2a and the auxiliary seat plate 2b, the shock absorber 310 slowly extends due to an elastic force of the spring 203.

11. The chair of claim 9, wherein the extensible support unit 601 comprises:
an outer container 300 that fixedly erects from the base 3;
a shock absorber 310 that is provided in the outer container 300;
a spindle 200 whose lower end portion is connected to the shock absorber 310 in the outer container 300 and upper end portion is fixed to a bottom surface of the main seat plate 2a; and
a spring that is provided in the shock absorber 310 and exerts an elastic force to extend the shock absorber 310,
wherein the main seat plate 2a and the auxiliary seat plate 2b which are connected to each other are vertically movable,
wherein when the user sits on the main seat plate 2a and the auxiliary seat plate 2b, the shock absorber 310 slowly compresses and when the user rises from the main seat plate 2a and the auxiliary seat plate 2b, the shock absorber 15 slowly extends due to an elastic force of the spring.

12. The chair of claim 9, wherein the extensible support unit 601 comprises:
an outer container 300 that fixedly erects from the base 3;
a motor cylinder that is provided in the outer container 300; and
a spindle 200 whose lower end portion is connected to the motor cylinder in the outer container 300 and upper end portion is fixed to a bottom surface of the main seat plate 2a,
wherein the main seat plate 2a and the auxiliary seat plate 2b which are connected to each other are vertically movable,
wherein as the motor cylinder compresses or extends, the main seat plate 2a is lowered or raised.

13. The chair of claim 10, wherein the outer container 300 is provided on the base 3 to be inclined at 1 to 10° toward the auxiliary seat plate 2b with respect to a direction perpendicular to the base 3.

14. A chair for easy-sitting and easy-rising motions, the chair comprising:
a seat plate 2 on which a user's hips may be placed;
an extensible support unit 602 whose upper end is pivotably fixed to a rear portion of the seat plate 2 and lower end portion contacts the ground under a front portion of the seat plate 2; and
a second support rod 12 whose upper end portion is pivotably fixed to the front portion of the seat plate 2 and lower end portion contacts the ground under the rear portion of the seat plate 2,
wherein the extensible support unit 602 comprises a first support rod 11 whose lower end portion contacts the ground, and a shock absorber 15 whose lower end portion is connected to the first support rod 11 and upper end portion is connected to the rear portion of the seat plate 2,
wherein the first support rod 11 and the second support rod 12 which cross each other in an X shape are pivotably coupled to each other by using a rod coupling pin 400.

15. The chair of claim 14, wherein the lower end portion of the second support rod 12 is fixed in position by being coupled to the base 3, and the lower end portion of the first support rod 11 has a wheel 31a provided thereon such that when the user sits on the chair, the lower end portion of the first support rod 11 moves forward and when the user rises from the chair, the lower end portion of the first support rod 11 moves backward.

16. The chair of claim 14, wherein the lower end portion of the first support rod 11 is fixed in position by being coupled to the base 3, and the lower end portion of the second support rod 12 has a wheel 32b provided thereon such that when the user sits on the chair, the lower end portion of the second support rod 12 moves forward and when the user rises from the chair, the lower end portion of the second support rod 12 moves backward.

17. A chair for easy-sitting and easy-rising motions, the chair comprising:
a seat plate 2 on which a user's hips may be placed;
a first support rod 401 whose upper end portion faces a rear portion of the seat plate 2 and lower end portion contacts the ground under a front portion of the seat plate 2;
a second support rod 402 whose upper end portion is pivotably fixed to the front portion of the seat plate 2 and lower end portion contacts the ground under the rear portion of the seat plate 2;
a connection rod 650 whose lower end is pivotably coupled to the upper end portion of the first support rod 401 by using a coupling pin 651 and upper end is pivotably coupled to a force application point 23 between a front end portion and a rear end portion of the seat plate 2, to couple the seat plate 2 and the second support rod 402;
a rod coupling pin 400 that couples the first support rod 401 to the second support rod 402 at an intersection point; and
a shock absorber 450 that is provided between the force application point 23 and the rod coupling pin 400.

18. The chair of claim 17, further comprising a second shock absorber 460 that is provided between the upper end portion of the first support rod 401 and the lower end portion of the second support rod 402.

19. A chair for easy-sitting and easy-rising motions, the chair comprising:
a seat plate 2 on which a user's hips may be placed;
a basic support rod 500 whose upper end portion is pivotably fixed to a front portion of the seat plate 2 and lower end portion is pivotably fixed to the ground under a rear portion of the seat plate 2;
a first shock absorber 510 whose upper end portion is pivotably fixed to a portion of the basic support rod 500 in a longitudinal direction of the basic support rod 500 and lower end portion is pivotably fixed to the ground under a front portion of the seat plate; and
a second shock absorber 520 whose upper end portion is pivotably fixed to the rear portion of the seat plate 2 and lower end portion is pivotably fixed to a portion of the basic support rod 500 in the longitudinal direction of the basic support rod 500.

20. A chair for easy-sitting and easy-rising motions, the chair comprising:
a seat plate 2 on which a user's hips may be placed;
an extensible support unit 602 whose upper end portion is pivotably fixed to a rear portion of the seat plate 2 and lower end portion contacts the ground under a front portion of the seat plate 2; and
a second support rod 12 whose upper end portion is pivotably fixed to the front portion of the seat plate 2 and lower end portion contacts the ground under the rear portion of the seat plate 2,
wherein the extensible support unit 602 comprises a first support rod 11 whose lower end portion contacts the ground, and a motor cylinder whose lower end portion is connected to the first support rod 11 and upper end portion is connected to the rear portion of the seat plate 2,
wherein the first support rod 11 and the second support rod 12 which cross each other in an X shape are pivotably coupled to each other by using a rod coupling pin 400.

21. A chair for easy-sitting and easy-rising motions, the chair comprising:
a seat plate 2 on which a user's hips may be placed;
a first support rod 401 whose upper end portion faces a rear portion of the seat plate 2 and lower end portion contacts the ground under a front portion of the seat plate 2;
a second support rod 402 whose upper end portion is pivotably fixed to the front portion of the seat plate 2 and lower end portion contacts the ground under the rear portion of the seat plate 2;
a connection rod 650 whose lower end is pivotably coupled to the upper end portion of the first support rod 401 by using a coupling pin 651 and upper end is pivotably coupled at a force application point 23 between a front end portion and a rear end portion of the seat plate 2, thereby connecting the second support rod 402 to the seat plate 2;
a rod coupling pin 400 that couples the first support rod 401 to the second support rod 402 at an intersection point; and
a motor cylinder that is provided between the force application point 23 and the rod coupling pin 400.

22. The chair of claim 21, further comprising a second motor cylinder that is provided between the upper end portion of the first support rod 401 and the lower end portion of the second support rod 402.

23. A chair for easy-sitting and easy-rising motions, the chair comprising:
a seat plate 2 on which a user's hips may be placed;
a basic support rod 500 whose upper end portion is pivotably fixed to a front portion of the seat plate 2 and lower end portion is pivotably fixed to the ground under a rear portion of the seat plate 2;
a motor cylinder whose upper end portion is pivotably fixed to a portion of the basic support rod 500 in a longitudinal direction of the basic support rod 500 and lower end portion is pivotably fixed to the ground under the front portion of the seat plate 2; and
a motor cylinder whose upper end portion is pivotably fixed to the rear portion of the seat plate 2 and lower end portion is pivotably fixed to a portion of the basic support rod 500 in the longitudinal direction of the basic support rod 500.
